(19) United States
(12) Patent Application Publication
(10) Pub. No.: US 2024/0340808 A1
(43) Pub. Date: Oct. 10, 2024

(54) METHOD FOR CONTROLLING POWER OF IAB NODE, AND DEVICE USING SAID METHOD

(71) Applicant: LG ELECTRONICS INC., Seoul (KR)

(72) Inventors: Jaenam SHIM, Seoul (KR); Hyangsun YOU, Seoul (KR); Hyunsoo KO, Seoul (KR); Haewook PARK, Seoul (KR)

(73) Assignee: LG ELECTRONICS INC., Seoul (KR)

(21) Appl. No.: 18/004,483

(22) PCT Filed: Jul. 6, 2021
(86) PCT No.: PCT/KR2021/008583

§ 371 Date: Jun. 21, 2024

(30) Foreign Application Priority Data
Jul. 6, 2020 (KR) 10-2020-0082542

(51) Int. Cl. H04W 52/36; H04B 7/06; H04W 76/20; H04W 88/08

(52) U.S. Cl. CPC H04W 52/367; H04B 7/0626; H04W 76/20; H04W 88/08

(57) ABSTRACT

The purpose of the present invention is to provide a method for controlling power of an IAB node, and a device using the method. A power control method performed by an IAB node for the purpose comprises: receiving power information, wherein the power information informs the IAB node of a configured power control method; and on the basis that the sum of an MT power for MT transmission and a DU power for DU transmission is greater than the maximum transmission power allocated to the LAB node, performing power control on at least one of the MT power and the DU power on the basis of the power information, wherein an MT resource on which the MT transmission is performed and a DU resource on which the DU transmission is performed overlap in a time domain.

### BACKGROUND OF THE DISCLOSURE

### Field of the Disclosure

The present disclosure relates to wireless communication.

### Related Art

One potential technology that aims to enable future cellular network deployment scenarios and applications is support for wireless backhaul and relay links, it enables flexible and highly dense deployment of NR cells without the need to proportionally densify the transport network.

Because greater bandwidth is expected to be available in NR compared to LTE with native deployment of massive MIMO or multi-beam systems (e.g. mmWave spectrum), opportunities are created for the development and deployment of integrated access and backhaul links. By establishing a number of control and data channels/procedures defined to provide connectivity or access to terminals, it allows easier deployment of a dense network of self-backhauled NR cells in a more integrated manner. These systems are referred to as integrated access and backhaul links (IAB).

### DISCLOSURE

### Technical Solution

This specification proposes a power control method of an IAB node and an apparatus using the method.

### Advantageous Effects

According to the present specification, a more flexible and highly efficient communication can be supported by proposing a method for distributing maximum transmission power that MTs and DUs of an IAB node can transmit at the same time.

The effects that can be obtained through specific examples of the present disclosure are not limited to the effects listed above. For example, there may be various technical effects that a person having ordinary skill in the related art can understand or derive from the present disclosure. Accordingly, specific effects of the present disclosure are not limited to those explicitly described in the present disclosure and may include various effects that can be understood or derived from the technical features of the present disclosure.

### BRIEF DESCRIPTION OF THE DRAWINGS

The following drawings are made to explain a specific example of the present specification. Since the names of specific devices or names of specific signals/messages/fields described in the drawings are provided as examples, the technical features of the present specification are not limited to the specific names used in the drawings below.

FIG. 1 shows a wireless communication system to which the present disclosure may be applied.

FIG. 2 is a diagram showing a wireless protocol architecture for a user plane.

FIG. 3 is a diagram showing a wireless protocol architecture for a control plane.

FIG. 4 shows another wireless communication system to which the present disclosure may be applied.

FIG. 5 illustrates a functional division between an NG-RAN and a 5GC.

FIG. 6 illustrates an example of a frame structure that may be applied in NR.

FIG. 7 illustrates a slot structure.

FIG. 8 illustrates CORESET.

FIG. 9 is a diagram illustrating a difference between a related art control region and the CORESET in NR.

FIG. 10 schematically illustrates an example for a network with integrated access and backhaul links (IAB).

FIG. 11 shows an example of the operation of the IAB system in a standalone (SA) mode and a non-standalone (NSA) mode.

FIG. 12 schematically illustrates an example of a configuration of access and backhaul links.

FIG. 13 is for explaining links and relationships between IAB nodes.

FIG. 14 shows an example in which two transmissions overlap.

FIG. 15 illustrates an example in which method 1-1 is applied.

FIG. 16 illustrates an example in which method 1-2 is applied.

FIG. 17 shows an example in which the method 1-4 is applied.

FIG. 18 is a flowchart of an example of a method for power control of an IAB node according to some implementations herein.

FIG. 19 is a flow chart of another example of a method for controlling power of an IAB node according to some implementations of the present disclosure.

FIG. 20 illustrates a communication system 1 applied to the disclosure.

FIG. 21 illustrates a wireless device that is applicable to the disclosure.

FIG. 22 illustrates a signal processing circuit for a transmission signal.

FIG. 23 illustrates another example of a wireless device applied to the disclosure.

FIG. 24 illustrates a hand-held device applied to the disclosure.

FIG. 25 illustrates a vehicle or an autonomous driving vehicle applied to the disclosure.

FIG. 26 illustrates a vehicle applied to the disclosure.

FIG. 27 illustrates a XR device applied to the disclosure.

FIG. 28 illustrates a robot applied to the disclosure.

FIG. 29 illustrates an AI device applied to the disclosure.

### DESCRIPTION OF EXEMPLARY EMBODIMENTS

As used herein, “A or B” may mean “only A”, “only B”, or “both A and B”. That is, “A or B” may be interpreted as “A and/or B” herein. For example, “A, B or C” may mean “only A”, “only B”, “only C”, or “any combination of A, B, and C”.

As used herein, a slash (/) or a comma (,) may mean “and/or”. For example, “A/B” may mean “A and/or B”. Therefore, “A/B” may include “only A”, “only B”, or “both A and B”. For example, “A, B, C” may mean “A, B, or C”.

As used herein, “at least one of A and B” may mean “only A”, “only B”, or “both A and B”. Further, as used herein, “at least one of A or B” or “at least one of A and/or B” may be interpreted equally as “at least one of A and B”.

As used herein, “at least one of A, B, and C” may mean “only A”, “only B”, “only C”, or “any combination of A, B, and C”. Further, “at least one of A, B, or C” or “at least one of A, B, and/or C” may mean “at least one of A, B, and C”.

As used herein, parentheses may mean “for example”. For instance, the expression “control information (PDCCH)” may mean that a PDCCH is proposed as an example of control information. That is, control information is not limited to a PDCCH, but a PDCCH is proposed as an example of control information. Further, the expression “control information (i.e., a PDCCH)” may also mean that a PDCCH is proposed as an example of control information.

Technical features individually described within a drawing in the present disclosure may be implemented individually or may be implemented simultaneously.

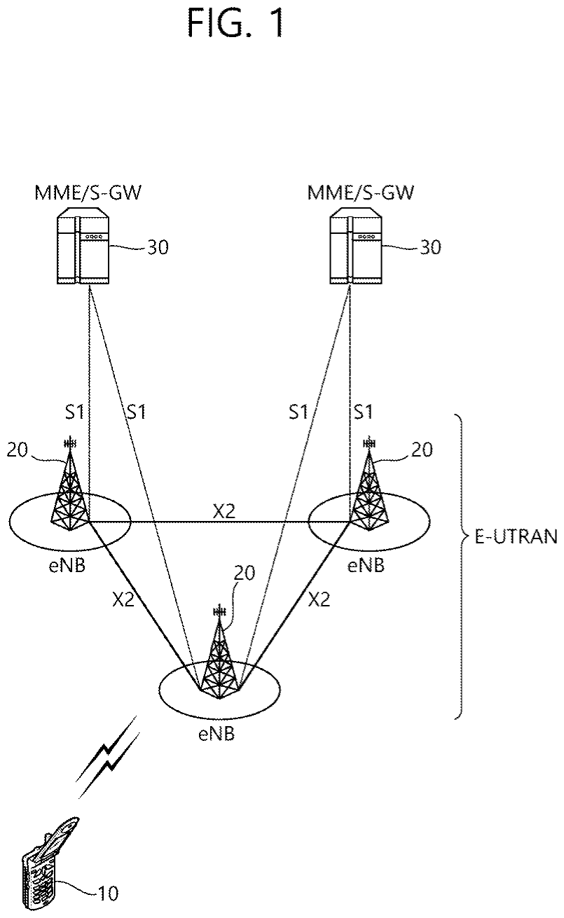

FIG. 1 shows a wireless communication system to which the present disclosure may be applied. The wireless communication system may be referred to as an Evolved-UMTS Terrestrial Radio Access Network (E-UTRAN) or a Long Term Evolution (LTE)/LTE-A system.

The E-UTRAN includes at least one base station (BS) 20 which provides a control plane and a user plane to a user equipment (UE) 10. The UE 10 may be fixed or mobile, and may be referred to as another terminology, such as a mobile station (MS), a user terminal (UT), a subscriber station (SS), a mobile terminal (MT), a wireless device, etc. The BS 20 is generally a fixed station that communicates with the UE 10 and may be referred to as another terminology, such as an evolved node-B (eNB), a base transceiver system (BTS), an access point, etc.

The BSs 20 are interconnected by means of an X2 interface. The BSs 20 are also connected by means of an S1 interface to an evolved packet core (EPC) 30, more specifically, to a mobility management entity (MME) through S1-MME and to a serving gateway (S-GW) through S1-U.

The EPC 30 includes an MME, an S-GW, and a packet data network-gateway (P-GW). The MME has access information of the UE or capability information of the UE, and such information is generally used for mobility management of the UE. The S-GW is a gateway having an E-UTRAN as an end point. The P-GW is a gateway having a PDN as an end point.

Layers of a radio interface protocol between the UE and the network can be classified into a first layer (L1), a second layer (L2), and a third layer (L3) based on the lower three layers of the open system interconnection (OSI) model that is well-known in the communication system. Among them, a physical (PHY) layer belonging to the first layer provides an information transfer service by using a physical channel, and a radio resource control (RRC) layer belonging to the third layer serves to control a radio resource between the UE and the network. For this, the RRC layer exchanges an RRC message between the UE and the BS.

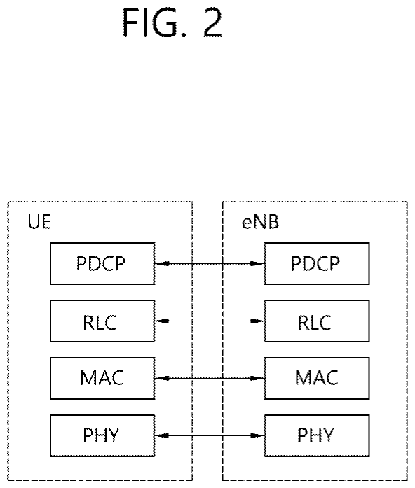

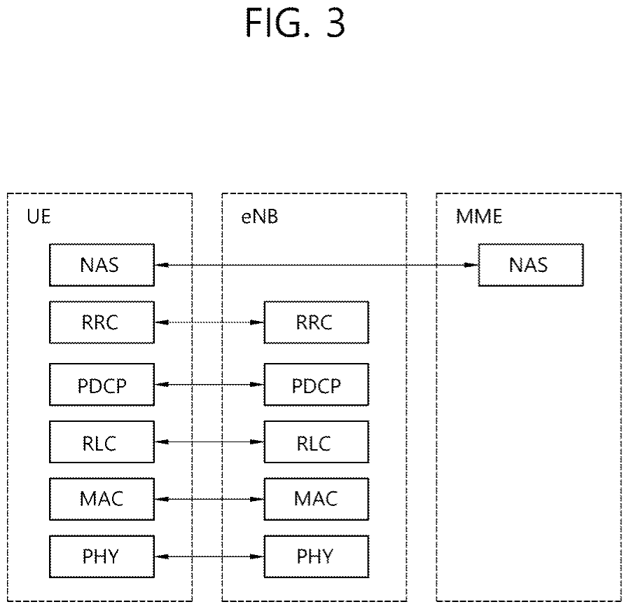

FIG. 2 is a diagram showing a wireless protocol architecture for a user plane. FIG. 3 is a diagram showing a wireless protocol architecture for a control plane. The user plane is a protocol stack for user data transmission. The control plane is a protocol stack for control signal transmission.

Referring to FIGS. 2 and 3, a PHY layer provides an upper layer with an information transfer service through a physical channel. The PHY layer is connected to a medium access control (MAC) layer which is an upper layer of the PHY layer through a transport channel. Data is transferred between the MAC layer and the PHY layer through the transport channel. The transport channel is classified according to how and with what characteristics data is transferred through a radio interface.

Data is moved between different PHY layers, that is, the PHY layers of a transmitter and a receiver, through a physical channel. The physical channel may be modulated according to an Orthogonal Frequency Division Multiplexing (OFDM) scheme, and use the time and frequency as radio resources.

The functions of the MAC layer include mapping between a logical channel and a transport channel and multiplexing and demultiplexing to a transport block that is provided through a physical channel on the transport channel of a MAC Service Data Unit (SDU) that belongs to a logical channel. The MAC layer provides service to a Radio Link Control (RLC) layer through the logical channel.

The functions of the RLC layer include the concatenation, segmentation, and reassembly of an RLC SDU. In order to guarantee various types of Quality of Service (QoS) required by a Radio Bearer (RB), the RLC layer provides three types of operation mode: Transparent Mode (TM), Unacknowledged Mode (UM), and Acknowledged Mode (AM). AM RLC provides error correction through an Automatic Repeat Request (ARQ).

The RRC layer is defined only on the control plane. The RRC layer is related to the configuration, reconfiguration, and release of radio bearers, and is responsible for control of logical channels, transport channels, and PHY channels. An RB means a logical route that is provided by the first layer (PHY layer) and the second layers (MAC layer, the RLC layer, and the PDCP layer) in order to transfer data between UE and a network.

The function of a Packet Data Convergence Protocol (PDCP) layer on the user plane includes the transfer of user data and header compression and ciphering. The function of the PDCP layer on the user plane further includes the transfer and encryption/integrity protection of control plane data.

What an RB is configured means a process of defining the characteristics of a wireless protocol layer and channels in order to provide specific service and configuring each detailed parameter and operating method. An RB can be divided into two types of a Signaling RB (SRB) and a Data RB (DRB). The SRB is used as a passage through which an RRC message is transmitted on the control plane, and the DRB is used as a passage through which user data is transmitted on the user plane.

If RRC connection is established between the RRC layer of UE and the RRC layer of an E-UTRAN, the UE is in the RRC connected state. If not, the UE is in the RRC idle state.

A downlink transport channel through which data is transmitted from a network to UE includes a broadcast channel (BCH) through which system information is transmitted and a downlink shared channel (SCH) through which user traffic or control messages are transmitted. Traffic or a control message for downlink multicast or broadcast service may be transmitted through the downlink SCH, or may be transmitted through an additional downlink multicast channel (MCH). Meanwhile, an uplink transport channel through which data is transmitted from UE to a network includes a random access channel (RACH) through which an initial control message is transmitted and an uplink shared channel (SCH) through which user traffic or control messages are transmitted.

Logical channels that are placed over the transport channel and that are mapped to the transport channel include a broadcast control channel (BCCH), a paging control channel (PCCH), a common control channel (CCCH), a multicast control channel (MCCH), and a multicast traffic channel (MTCH).

The physical channel includes several OFDM symbols in the time domain and several subcarriers in the frequency domain. One subframe includes a plurality of OFDM symbols in the time domain. An RB is a resources allocation unit, and includes a plurality of OFDM symbols and a plurality of subcarriers. Furthermore, each subframe may use specific subcarriers of specific OFDM symbols (e.g., the first OFDM symbol) of the corresponding subframe for a physical downlink control channel (PDCCH), that is, an L1/L2 control channel. A Transmission Time Interval (TTI) is a unit time for transmission, e.g., a subframe or a slot.

Hereinafter, a new radio access technology (new RAT, NR) will be described.

As more and more communication devices require more communication capacity, there is a need for improved mobile broadband communication over existing radio access technology. Also, massive machine type communications (MTC), which provides various services by connecting many devices and objects, is one of the major issues to be considered in the next generation communication. In addition, communication system design considering reliability/latency sensitive service/UE is being discussed. The introduction of next generation radio access technology considering enhanced mobile broadband communication (eMBB), massive MTC (mMTC), ultrareliable and low latency communication (URLLC) is discussed. This new technology may be called new radio access technology (new RAT or NR) in the present disclosure for convenience.

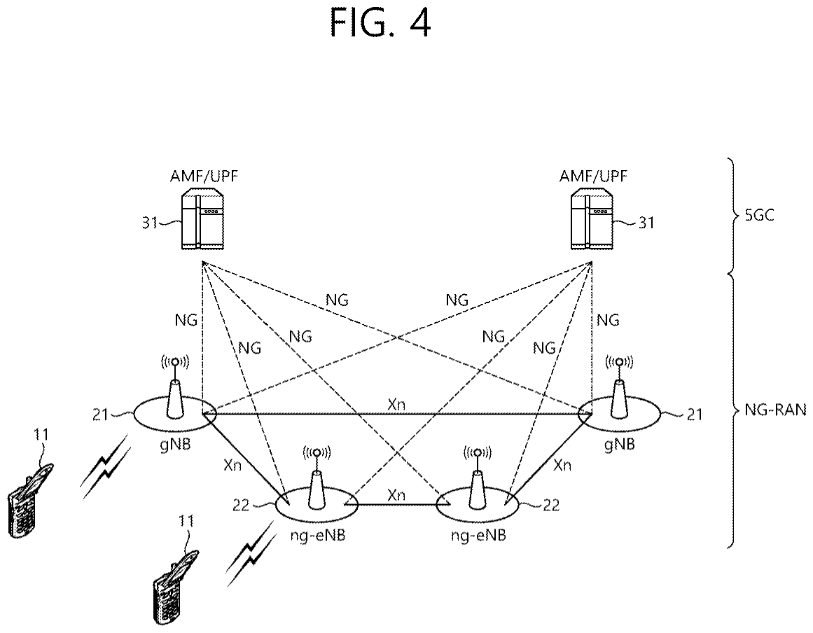

FIG. 4 shows another wireless communication system to which the present disclosure may be applied.

Specifically, FIG. 4 shows a system architecture based on a 5G new radio access technology (NR) system. An entity used in the 5G NR system (hereinafter, simply referred to as “NR”) may absorb some or all functions of the entity (e.g., eNB, MME, S-GW) introduced in FIG. 1 (e.g., eNB, MME, S-GW). The entity used in the NR system may be identified in the name of “NG” to distinguish it from LTE.

Referring to FIG. 4, a wireless communication system includes one or more UEs 11, a next-generation RAN (NG-RAN), and a 5^{th} generation core network (5GC). The NG-RAN consists of at least one NG-RAN node. The NG-RAN node is an entity corresponding to the BS 20 of FIG. 1. The NG-RAN node consists of at least one gNB 21 and/or at least one ng-eNB 22. The gNB 21 provides NR user plane and control plane protocol terminations towards the UE 11. The Ng-eNB 22 provides an E-UTRA user plane and control plane protocol terminations towards the UE 11.

The 5GC includes an access and mobility management function (AMF), a user plane function (UPF), and a session management function (SMF). The AMF hosts functions, such as non-access stratum (NAS) security, idle state mobility processing, and so on. The AMF is an entity including the conventional MMF function. The UPF hosts functions, such as mobility anchoring, protocol data unit (PDU) processing, and so on. The UPF is an entity including the conventional S-GW function. The SMF hosts functions, such as UE Internet Protocol (IP) address allocation, PDU session control, and so on.

The gNB and the ng-eNB are interconnected through an Xn interface. The gNB and the ng-eNB are also connected to the 5GC through an NG interface. More specifically, the gNB and the ng-eNB are connected to the AMF through an NG-C interface, and are connected to the UPF through an NG-U interface.

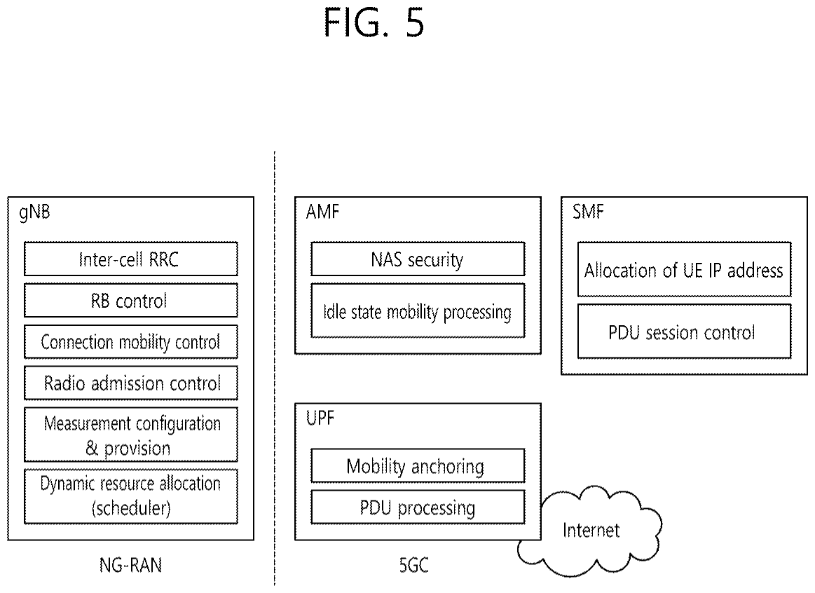

FIG. 5 illustrates a functional division between an NG-RAN and a 5GC.

Referring to FIG. 5, the gNB may provide functions such as an inter-cell radio resource management (Inter Cell RRM), radio bearer management (RB control), connection mobility control, radio admission control, measurement configuration & provision, dynamic resource allocation, and the like. The AMF may provide functions such as NAS security, idle state mobility handling, and so on. The UPF may provide functions such as mobility anchoring, PDU processing, and the like. The SMF may provide functions such as UE IP address assignment, PDU session control, and so on.

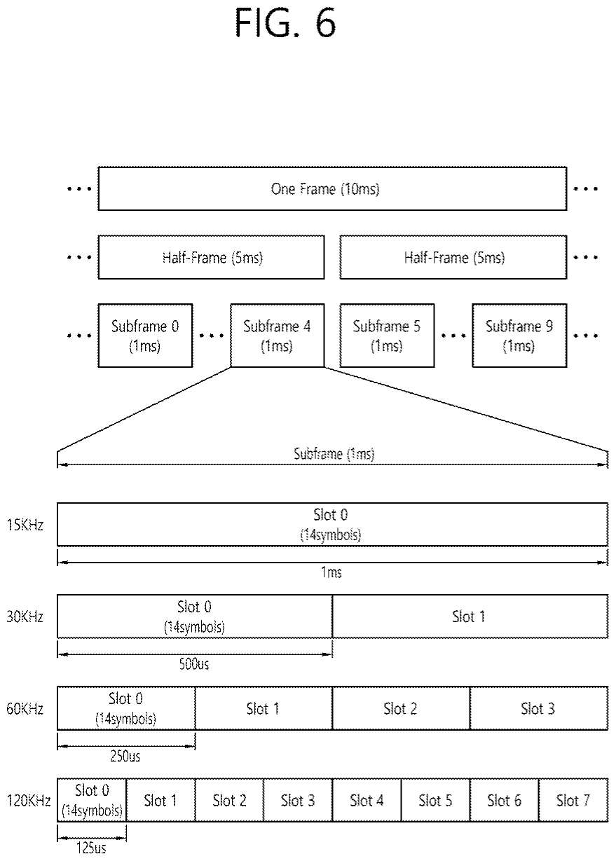

FIG. 6 illustrates an example of a frame structure that may be applied in NR.

Referring to FIG. 6, a frame may be composed of 10 milliseconds (ms) and include 10 subframes each composed of 1 ms.

In the NR, uplink and downlink transmissions may be configured on a frame basis. A radio frame has a length of 10 ms, and may be defined as two 5 ms half-frames (HFs). The HF may be defined as five 1 ms sub-frames (SFs). The SF is divided into one or more slots, and the number of slots in the SF depends on a subcarrier spacing (SCS). Each slot includes 12 or 14 OFDM (A) symbols according to a cyclic prefix (CP). When a normal CP is used, each slot includes 14 symbols. When an extended CP is used, each slot includes 12 symbols. Herein, the symbol may include an OFDM symbol (or CP-OFDM symbol) and an SC-FDMA symbol (or DFT-S-OFDM symbol).

One or a plurality of slots may be included in a subframe according to subcarrier spacings.

The following table 1 illustrates a subcarrier spacing configuration μ.

TABLE 1

| μ | Δf = 2^{μ} · 15[kHz] | Cyclic prefix |
|---|---|---|
| 0 | 15 | Normal |
| 1 | 30 | Normal |
| 2 | 60 | Normal Extended |
| 3 | 120 | Normal |
| 4 | 240 | Normal |

The following table 2 illustrates the number of slots in a frame (N^{frame,μ}ₛₗₒₜ), the number of slots in a subframe (N^{subframe,μ}ₛₗₒₜ), the number of symbols in a slot (N^{slot}_{symb}), and the like, according to subcarrier spacing configurations μ.

TABLE 2

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 3 below illustrates that the number of symbols per slot, the number of slots per frame, and the number of slots per subframe vary depending on the SCS, in case of using an extended CP.

TABLE 3

| SCS(15*2\hat{ }μ) | N^{slot}_{symb} | N^{frame, u}ₛₗₒₜ | N^{subframe, u}ₛₗₒₜ |
|---|---|---|---|
| 60 KHz (μ = 2) | 12 | 40 | 4 |

NR supports multiple numbers (or subcarrier spacing (SCS)) to support various 5G services. For example, when the SCS is 15 kHz, a wide region in the legacy cellular band is supported; and when the SCS is 30 kHz/60 kHz, dense urban areas, low time delay and wide carrier bandwidth are supported; and when the SCS is 60 kHz or more, a bandwidth of more than 24.25 GHz is supported in order to overcome phase noise.

The NR frequency band may be defined as two types of frequency ranges (FR1 and FR2). A numerical value of the frequency range may be changed and, for example, the two types of frequency ranges (FR1 and FR2) may be as shown in Table 4 below. For convenience of explanation, among the frequency ranges used in the NR system, FR1 may refer to “sub 6 GHz range” and FR2 may refer to “above 6 GHz range” and may be called millimeter wave (mmW).

TABLE 4

| Frequency Range | Corresponding | |
|---|---|---|
| designation | frequency range | Subcarrier Spacing |
| FR1 | 450 MHz-6000 MHz | 15, 30, 60 kHz |
| FR2 | 24250 MHz-52600 MHz | 60, 120, 240 kHz |

As described above, the numerical value of the frequency range of the NR system may be changed. For example, FR1 may include a band of 410 MHz to 7125 MHz as shown in Table 5 below. That is, FR1 may include a frequency band of 6 GHz (or 5850, 5900, 5925 MHz, etc.) or higher. For example, the frequency band of 6 GHz (or 5850, 5900, 5925 MHz, etc.) or higher included in FR1 may include an unlicensed band. The unlicensed band may be used for various purposes, for example, for communication for a vehicle (e.g., autonomous driving).

TABLE 5

| Frequency Range | Corresponding | |
|---|---|---|
| designation | frequency range | Subcarrier Spacing |
| FR1 | 410 MHz-7125 MHz | 15, 30, 60 kHz |
| FR2 | 24250 MHz-52600 MHz | 60, 120, 240 kHz |

In an NR system, OFDM (A) numerologies (e.g., SCS, CP length, and so on) may be differently configured between a plurality of cells integrated to one UE. Accordingly, an (absolute time) duration of a time resource (e.g., SF, slot or TTI) (for convenience, collectively referred to as a time unit (TU)) configured of the same number of symbols may be differently configured between the integrated cells.

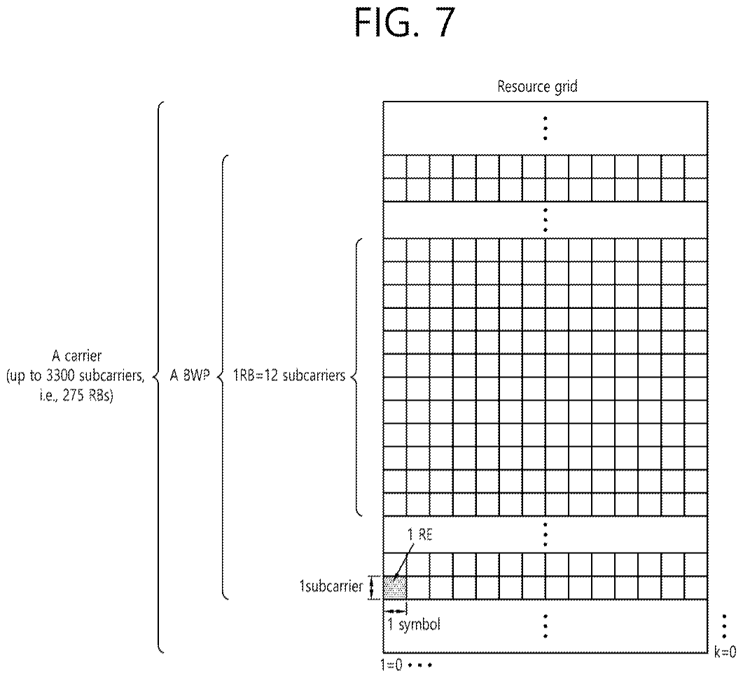

FIG. 7 illustrates a slot structure.

Referring to FIG. 7, a slot includes a plurality of symbols in a time domain. For example, in case of a normal CP, one slot may include 14 symbols. However, in case of an extended CP, one slot may include 12 symbols. Alternatively, in case of the normal CP, one slot may include 7 symbols. However, in case of the extended CP, one slot may include 6 symbols.

A carrier includes a plurality of subcarriers in a frequency domain. A resource block (RB) may be defined as a plurality of consecutive subcarriers (e.g., 12 subcarriers) in the frequency domain. A bandwidth part (BWP) may be defined as a plurality of consecutive (P)RBs in the frequency domain, and the BWP may correspond to one numerology (e.g., SCS, CP length, and so on). The carrier ma include up to N (e.g., 5) BWPs. Data communication may be performed through an activated BWP. Each element may be referred to as a resource element (RE) within a resource grid, and one complex symbol may be mapped thereto.

A physical downlink control channel (PDCCH) may include one or more control channel elements (CCEs) as illustrated in the following table 6.

TABLE 6

| Aggregation level | Number of CCEs |
|---|---|
| 1 | 1 |
| 2 | 2 |
| 4 | 4 |
| 8 | 8 |
| 16 | 16 |

That is, the PDCCH may be transmitted through a resource including 1, 2, 4, 8, or 16 CCEs. Here, the CCE includes six resource element groups (REGs), and one REG includes one resource block in a frequency domain and one orthogonal frequency division multiplexing (OFDM) symbol in a time domain.

A new unit called a control resource set (CORESET) may be introduced in the NR. The UE may receive a PDCCH in the CORESET.

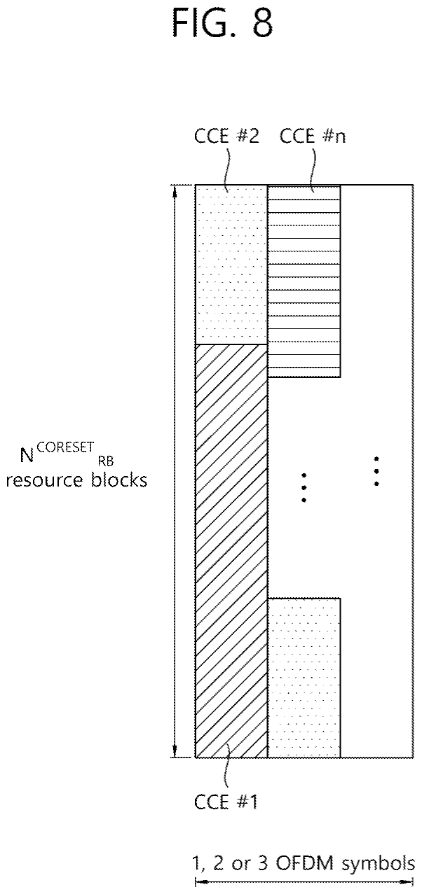

FIG. 8 illustrates CORESET.

Referring to FIG. 8, the CORESET includes N^{CORESET}_{RB} number of resource blocks in the frequency domain, and N^{CORESET}_{symb}∈{1, 2, 3} number of symbols in the time domain. N^{CORESET}_{RB} and N^{CORESET}_{symb} may be provided by a base station via higher layer signaling. As illustrated in FIG. 8, a plurality of CCEs (or REGs) may be included in the CORESET.

The UE may attempt to detect a PDCCH in units of 1, 2, 4, 8, or 16 CCEs in the CORESET. One or a plurality of CCEs in which PDCCH detection may be attempted may be referred to as PDCCH candidates.

A plurality of CORESETs may be configured for the terminal.

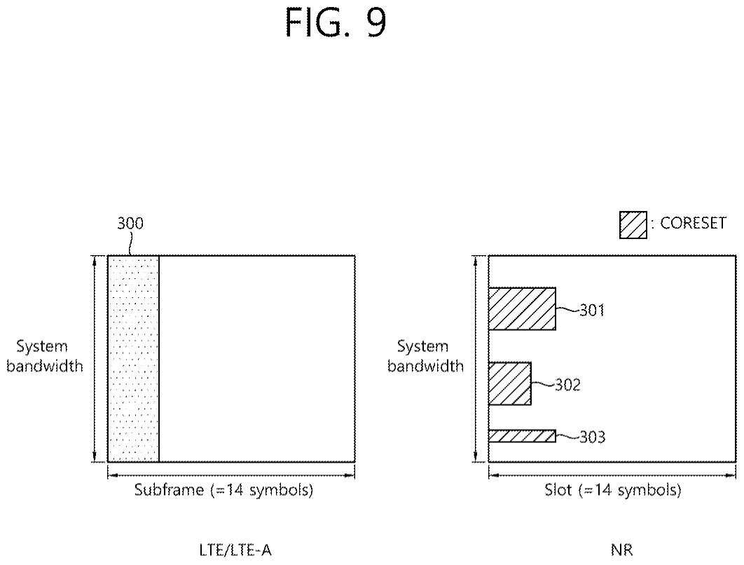

FIG. 9 is a diagram illustrating a difference between a related art control region and the CORESET in NR.

Referring to FIG. 9, a control region 300 in the related art wireless communication system (e.g., LTE/LTE-A) is configured over the entire system band used by a base station (BS). All the terminals, excluding some (e.g., eMTC/NB-IoT terminal) supporting only a narrow band, must be able to receive wireless signals of the entire system band of the BS in order to properly receive/decode control information transmitted by the BS.

On the other hand, in NR, CORESET described above was introduced. CORESETs 301, 302, and 303 are radio resources for control information to be received by the terminal and may use only a portion, rather than the entirety of the system bandwidth. The BS may allocate the CORESET to each UE and may transmit control information through the allocated CORESET. For example, in FIG. 9, a first CORESET 301 may be allocated to UE 1, a second CORESET 302 may be allocated to UE 2, and a third CORESET 303 may be allocated to UE 3. In the NR, the terminal may receive control information from the BS, without necessarily receiving the entire system band.

The CORESET may include a UE-specific CORESET for transmitting UE-specific control information and a common CORESET for transmitting control information common to all UEs.

Meanwhile, NR may require high reliability according to applications. In such a situation, a target block error rate (BLER) for downlink control information (DCI) transmitted through a downlink control channel (e.g., physical downlink control channel (PDCCH)) may remarkably decrease compared to those of conventional technologies. As an example of a method for satisfying requirement that requires high reliability, content included in DCI can be reduced and/or the amount of resources used for DCI transmission can be increased. Here, resources can include at least one of resources in the time domain, resources in the frequency domain, resources in the code domain and resources in the spatial domain.

Hereinafter, an integrated access and backhaul link (IAB) will be described. Meanwhile, in the following, for convenience of description, a proposed scheme based on a new RAT (NR) system will be described. However, the range of systems to which the proposed scheme is applied can be extended to other systems such as 3GPP LTE/LTE-A systems in addition to NR systems.

One potential technology that aims to enable future cellular network deployment scenarios and applications is support for wireless backhaul and relay links, it enables flexible and highly dense deployment of NR cells without the need to proportionally densify the transport network.

Because greater bandwidth is expected to be available in NR compared to LTE with native deployment of massive MIMO or multi-beam systems (e.g. mmWave spectrum), opportunities are created for the development and deployment of integrated access and backhaul links. By establishing a number of control and data channels/procedures defined to provide connectivity or access to terminals, this allows easier deployment of a dense network of self-backhauled NR cells in a more integrated manner. These systems are referred to as integrated access and backhaul links (IAB).

The present disclosure defines:
AC(x): access link between node (x) and terminal(s).
BH(xy): Backhaul link between node (x) and node (y).

In this case, the node may mean a donor gNB (DgNB) or a relay node (RN). Here, the DgNB or donor node may be a gNB that provides a function of supporting backhaul for IAB nodes.

In addition, in the present disclosure, for convenience of description, when relay node 1 and relay node 2 exist, when relay node 1 is connected to relay node 2 through a backhaul link and relays data transmitted to and received from relay node 2, relay node 1 is referred to as a parent node of relay node 2, relay node 2 is called a child node of relay node 1.

The following drawings are made to explain a specific example of the present specification. Since the names of specific devices or names of specific signals/messages/fields described in the drawings are provided as examples, the technical features of the present specification are not limited to the specific names used in the drawings below.

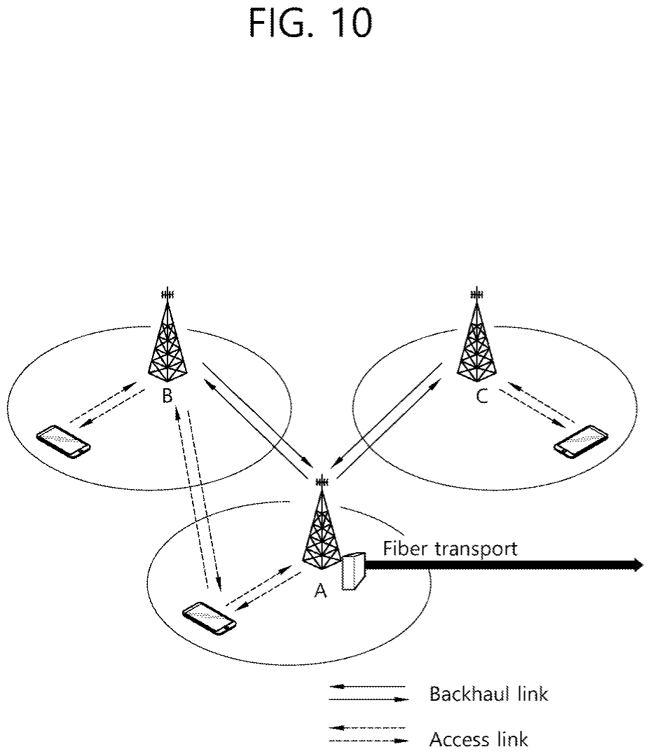

FIG. 10 schematically illustrates an example for a network with integrated access and backhaul links (IAB).

According to FIG. 10, relay nodes (rTRPs) may multiplex access and backhaul links in the time, frequency, or space domain (i.e., beam-based operation).

The operation of the different links may operate on the same frequency or on different frequencies (which may be referred to as ‘in-band’ or ‘out-band’ relays, respectively). Efficient support of out-of-band relays is important for some NR deployment scenarios, it is very important to understand the requirements of in-band operation, which include accommodating duplex limitations and interworking closely with access links operating on the same frequency to avoid/mitigate interference.

Furthermore, operating an NR system in the millimeter wave spectrum presents some unique challenges including experiencing severe short-term blocking that may not be easily mitigated by current RRC-based handover mechanisms due to the larger time scale required for completion of the procedure compared to shorter blocking. Overcoming short blocking in mm Wave systems may require a fast RAN-based mechanism for switching between rTRPs that does not necessarily require the inclusion of a core network. With the need for easier deployment of self-backhauled NR cells, the foregoing requirement for mitigation of short blocking for NR operation in the millimeter wave spectrum creates a need for the development of an integrated framework that allows fast switching of access and backhaul links. Over-the-air (OTA) coordination between rTRPs can also be considered to mitigate interference and support end-to-end path selection and optimization.

The following requirements and aspects shall be addressed by the IAB for NR.
Efficient and flexible operation for in-band and out-of-band relaying in indoor and outdoor scenarios
Multi-hop and redundant connections
End-to-end path selection and optimization
Support of backhaul links with high spectral efficiency
Support of legacy NR terminals

Legacy NR is designed to support half-duplex devices. Thus, in an IAB scenario, half-duplex is supported and may be worth targeting. Furthermore, IAB devices with full duplex can also be considered.

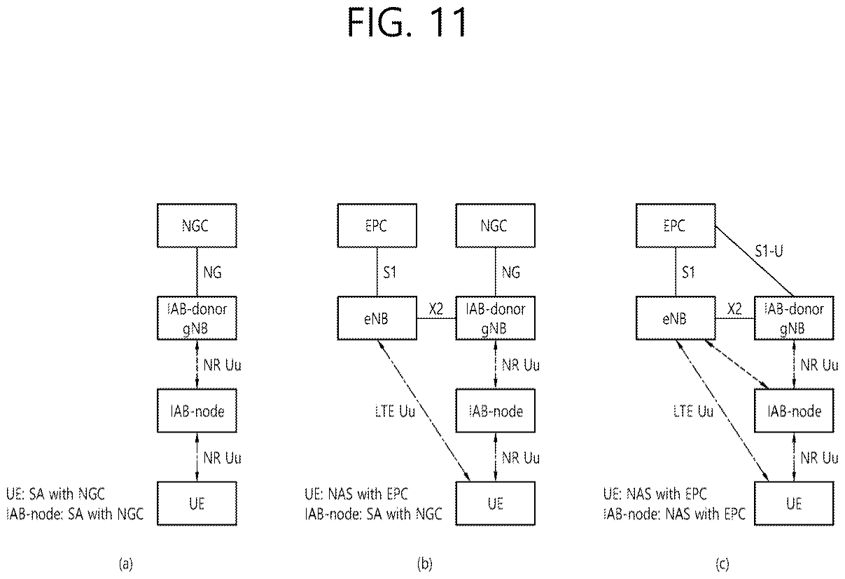

FIG. 11 shows an example of the operation of the IAB system in a standalone (SA) mode and a non-standalone (NSA) mode. Specifically, (a) of FIG. 11 shows an example of an operation of a terminal and an IAB node considering NGC in SA mode, (b) of FIG. 11 shows an example of an operation of an IAB node considering NGC in SA mode and a terminal considering EPC in NSA mode, (c) of FIG. 11 shows an example of an operation of a terminal and an IAB node considering EPC in NSA mode.

An IAB node can operate in SA mode or NSA mode. When operating in NSA mode, the IAB node uses only the NR link for backhauling. A terminal connected to the IAB node may select an operation mode different from that of the IAB node. The terminal may further connect to a core network of a different type from the connected IAB node. In this case, (e) DECOR ((enhanced) dedicated core network) or slicing may be used for CN selection. An IAB node operating in NSA mode may be connected to the same or different eNB(s). Terminals operating in NSA mode may be connected to the same or different eNBs as the IAB node to which they are connected. FIG. 11 shows an example considering NGC in SA mode and an example considering EPC in NSA mode.

In an IAB scenario, if each relay node (RN) does not have scheduling capability, a donor gNB (DgNB) has to schedule all links between the DgNB, related relay nodes and terminals. In other words, the DgNB must make a scheduling decision for all links by collecting traffic information from all related relay nodes, and then inform each relay node of the scheduling information.

On the other hand, distributed scheduling can be performed when each relay node has scheduling capability. Then, immediate scheduling for the uplink scheduling request of the UE is possible, and the backhaul/access link can be used more flexibly by reflecting the surrounding traffic situation.

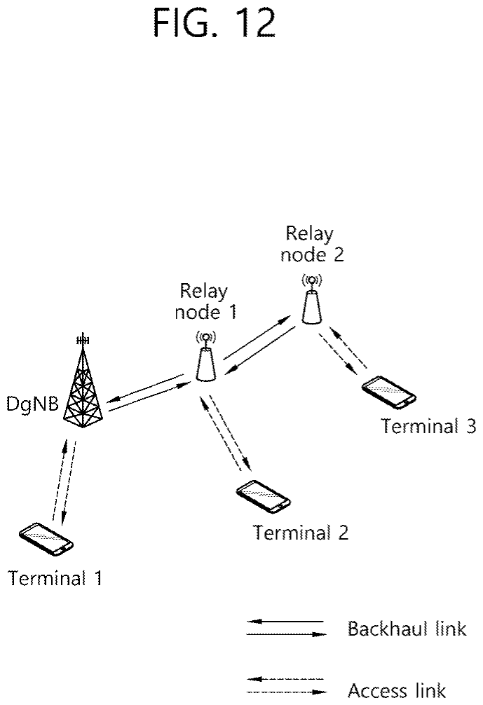

FIG. 12 schematically illustrates an example of a configuration of access and backhaul links.

FIG. 12 shows an example in which a backhaul link and an access link are configured when DgNB and IAB relay nodes (RNs) are present. DgNB and RN1 connect backhaul links, and RN2 connects backhaul links to RN1. DgNB and UE1 (UE1) connect access links, RN1 and UE2 connect access links, and RN2 and UE3 connect access links.

According to FIG. 12, the DgNB not only receives a scheduling request from UE 1, but also receives scheduling requests from UE2 and UE3. Then, the DgNB makes a scheduling decision of the two backhaul links and the three access links, and informs the scheduling results. Therefore, such centralized scheduling involves scheduling delays and causes latency problems.

On the other hand, distributed scheduling can be performed if each relay node has scheduling capability. Then, immediate scheduling for the uplink scheduling request of the UE can be performed, and the backhaul/access links can be used more flexibly by reflecting the surrounding traffic situation.

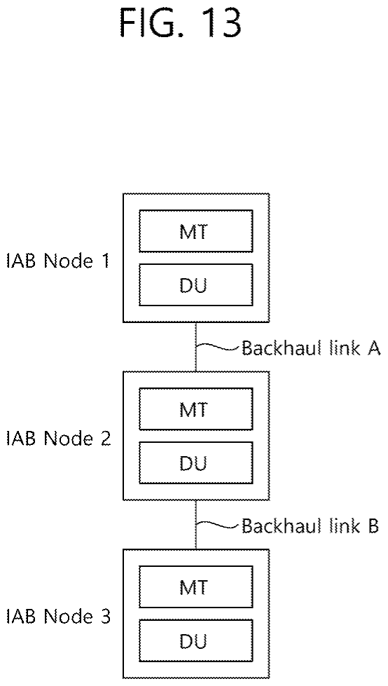

FIG. 13 is for explaining links and relationships between IAB nodes.

Referring to FIG. 13, IAB node 1 is connected to IAB node 2 through backhaul link A. For backhaul link A, IAB node 1 is the parent node of IAB node 2, and IAB node 2 is the child node of IAB node 1. In addition, IAB node 2 is connected to IAB node 3 through backhaul link B, and IAB node 2 is a parent node of IAB node 3 and IAB node 3 is a child node of IAB node 2 for backhaul link B.

Here, each of the IAB nodes may perform two functions. One is mobile termination (MT), which maintains a wireless backhaul connection to the parent IAB node or donor node, the other is a distributed unit (DU), which provides an access connection with terminals or a connection with an MT of a lower IAB node.

For example, from the point of view of IAB node 2, the DU of IAB node 2 has a functional backhaul link B with the MT of IAB node 3, at the same time, the MT of IAB node 2 has a functional backhaul link A with the DU of IAB node 1. Here, the child link of the DU of IAB node 2 may mean backhaul link B between IAB node 2 and IAB node 3. Also, here, the parent link of the MT of the IAB node 2 may mean the backhaul link A between the IAB node 2 and the IAB node 1.

Meanwhile, from the perspective of the IAB node MT (or simply MT), the following time domain resources may be indicated for the parent link.
Downlink (DL) time resource
Uplink (UL) time resource
Flexible (F) time resource

From the point of view of the IAB node DU (or simply DU), a child link has the following time resource types.
Downlink (DL) time resource
Uplink (UL) time resource
Flexible (F) time resource
Not-available (NA) time resources (resources not used for communication on the DU child link)

Meanwhile, each of the downlink time resource, uplink time resource, and flexible time resource of the DU child link may belong to one of the following two categories.
Hard resource: always available time resource for DU child link
Soft resources: Time resources in which the availability of time resources for the DU child link is explicitly or implicitly controlled by the parent node

Meanwhile, the foregoing is only an arbitrary classification, resource types from the perspective of the IAB node DU are UL, DL, and F, and availability settings may be classified into NA, hard resources, and soft resources, respectively. Specifically, the IAB node may receive resource configuration information, where the resource configuration information may include link direction information and availability information. Here, the link direction information may inform whether the type of a specific resource is UL, DL, or F, and the availability information may inform whether a specific resource is a hard resource or a soft resource. Alternatively, the link direction information may inform whether the type of a specific resource is UL, DL, F, or NA, and the availability information may inform whether a specific resource is a hard resource or a soft resource.

In the following, the proposal of the present disclosure will be described in more detail.

The following drawings are made to explain a specific example of the present specification. Since the names of specific devices or names of specific signals/messages/fields described in the drawings are provided as examples, the technical features of the present specification are not limited to the specific names used in the drawings below. In addition, the methods/configurations proposed in this specification may be combined in various ways.

Existing IAB nodes perform time division multiplexing (TDM) operations in which DUs and MTs operate through different time resources. On the other hand, in a next-generation communication system, it is required to perform resource multiplexing such as spatial division multiplexing (SDM), frequency division multiplexing (FDM), or full duplexing (FD) between a DU and an MT for efficient resource management. As shown in FIG. 13, a link between an IAB node (IAB MT) and a parent node (parent DU) is referred to as a parent link, and a link between an IAB node (IAB DU) and a child node (child MT) is referred to as a child link. At this time, in addition to the TDM operation between the parent link and the child link, SDM, FDM, and FD operations are being discussed.

On the other hand, the MT transmission power of the IAB node is indicated by the DU of the parent IAB node in consideration of the MT's capability and regulation, and the IAB node determines the DU transmission power of the IAB node, it doesn't matter if you transmit on different time resources. However, if the MT and DU within a single IAB node transmit at the same time, that is, transmit simultaneously, due to device limitations, restrictions, or lack of transmit power, the MT may be allocated less transmit power than the instructed transmit power, similarly, DUs may not be able to transmit with intended transmit power. That is, transmission of MTs and DUs may require more power than the sum of powers transmittable by the IAB node in time resources where transmissions of MTs and DUs of the IAB node overlap.

If the MT and DU of the IAB node require the maximum transmission power that the IAB node can transmit at the same time, it is necessary to discuss who will preemptively use the power. In this regard, in the current NR, the priority of transmission considers only the priority in uplink transmission of the UE. However, due to the nature of the IAB system, since MTs and DUs in an IAB node are in a single node, downlink transmission and uplink transmission may overlap in time resources. Therefore, the IAB system requires different priority rules, and in this specification, a transmission power allocation method for MTs and DUs in an IAB node is proposed.

The contents of this specification are described assuming a no-TDM relationship between a DU and an MT in an IAB node, that is, an environment in which TDM is not applied, but can also be applied in an environment in which a DU and an MT in an IAB node have a TDM relationship. Specifically, even in the TDM environment, if H (hard)/S (soft)/NA (not-available) settings and AI settings are made, simultaneous transmission of DUs and MTs in the IAB node is allowed, in the hard and soft (soft with AI indication) resources of the DU, the DU may be given priority in power allocation, and the MT may be given priority in the remaining cases. However, a signal requiring priority for downlink transmission of a DU may be allocated power with the highest priority and may not be considered for power sharing. Here, a signal requiring priority for downlink transmission may be at least one of an SSB/PBCH block and a CSI-RS. In addition, when the transmission power of the downlink of the DU is lowered, transmit power of a signal (e.g., SS/PBCH block, DMRS, PT-RS, etc.) for which the received power level is not expected to change from the UE's point of view can be maintained.

In this specification, the maximum power that the MT and DU of the IAB node can transmit in unit time is called P_{IAB}, the maximum power of MT is P_{MT}, and the maximum power of DU is P_{DU}. P_{MT} may be equal to Pcmax of an existing UE. Priority is given to transmit power distribution for the scenarios and methods described below. Alternatively, assigning priority may be allocating the maximum transmittable power, the value of the maximum power may be a predetermined constant or a value according to a function of time/frequency. Conversely, it may mean allocating power equal to or less than (P_{IAB}−P_{DU}) or (P_{IAB}−P_{MT}) power of MTs or DUs that do not have priority.

Hereinafter, definition of overlapping time resources between MTs and DUs in an IAB node and a transmission power change application period will be described.

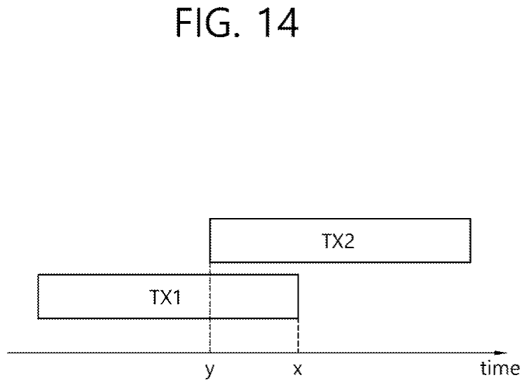

FIG. 14 shows an example in which two transmissions overlap.

When DUs and MTs of an IAB node are simultaneously transmitted, that is, transmission of DUs and transmissions of MTs overlap in time resources, power distribution for each transmission may be a problem. Here, referring to FIG. 14, overlapping can mean the case where two transmissions overlap at a certain time, that is, the case in which the end point (x) of the earlier transmission (TX1) in time lags behind the start point (y) of the later transmission (TX2) in time between MT transmission and DU transmission, that is, the case where y<x.

The overlapping time (x-y) of two transmissions may be a plurality of slots or symbols, and the following case may be considered for adjusting transmission power accordingly. If the overlapping time (x-y) is more than one slot in terms of TX1 or TX2 or both TX1 and TX2, it can be determined that a plurality of slots overlap, in the case of one slot or less, it may be determined that a plurality of symbols overlap. Here, the transmission power control may be performed only in overlapping sections or may be performed in overlapping sections and other areas. For example, referring to FIG. 14, it may be necessary to change transmit power of TX1 and TX2 or both of TX1 and TX2 according to transmission power distribution in overlapping intervals of TX1 and TX2. At this time, the case where the sum of the configured powers for the downlink transmission of the DU of the IAB node and the uplink transmission of the MT does not exceed the PIAB, that is, the case where the transmission power is not insufficient is not described herein. In addition, a method of reducing transmission power of TX1 or TX2 according to implementation is not separately described.

Hereinafter, the case of overlapping at the slot level will be described.

When the transmission time of downlink transmission of DU or uplink transmission of MT overlaps over N (N is 1 or more) slots, that is, when the sum of the powers set for downlink transmission of DU and uplink transmission of MT exceeds PIAB, the following methods may be considered. At this time, the DU or MT that reduces the transmission power can transmit by reducing the total power for its overlapping slot.

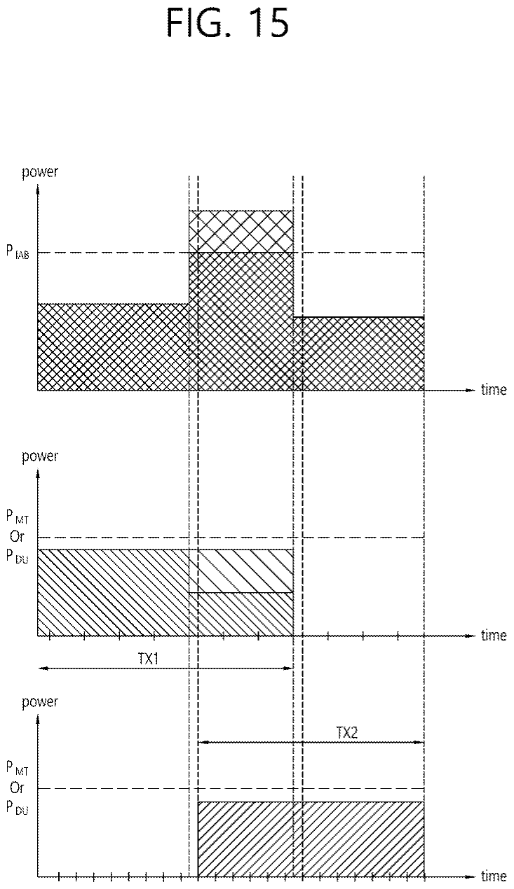

(Method 1-1) Transmission power of downlink transmission of DUs or uplink transmission of MTs may be reduced or dropped only for the overlapping N slots. At this time, the transmit power of the slot in which the downlink transmission of the DU and the uplink transmission of the MT do not overlap may be transmitted while maintaining the set power. For example, according to the above method 1-1, when TX1 and TX2 overlap in the time domain, when the transmission power of TX1 is lowered, the operation as shown in FIG. 15 can be performed. FIG. 15 illustrates an example in which method 1-1 is applied. Referring to FIG. 15 and FIGS. 16 and 17 described later, the time axis scales of TX1 and TX2 mean slots, the entire hatched area means the total power allocated, relatively less dense hatching, i.e., coarser parts, means reduced power. As an example, referring to FIG. 15, when TX1 and TX2 partially overlap in the time domain, the transmit power of TX2 has no reduced portion, the transmit power of TX1 is obtained by partially reducing the transmit power in the overlapped time domain.

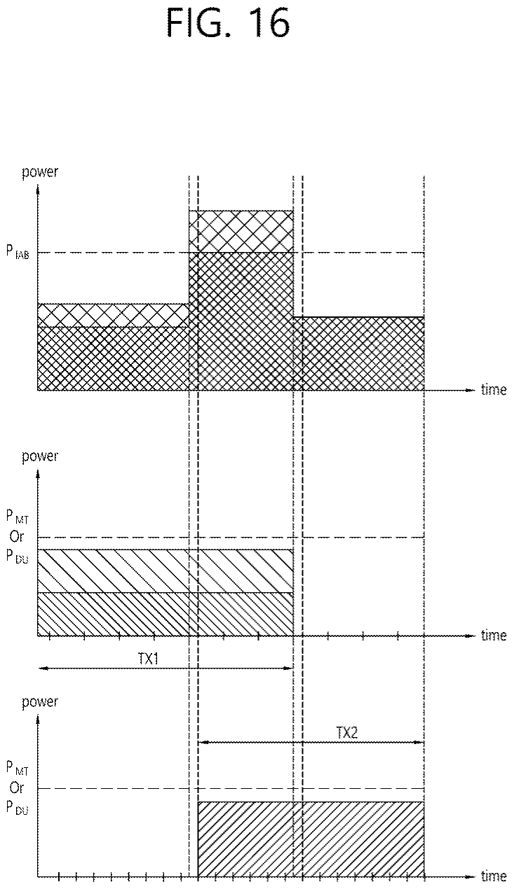

(Method 1-2) For the overlapping N or more slots, the downlink transmission of the DU or the uplink transmission of the MT having a preceding transmission time may be transmitted by lowering or dropping the transmission power. That is, for N or more slots of downlink transmission of the preceding DU or uplink transmission of MT, for example, reduce transmission power or drop transmission for N or more slots preceding in time from time x in FIG. 14, the transmit power of the uplink transmission of the following MT or the downlink transmission of the DU is not affected. That is, the transmit power corresponding to TX2 in FIG. 14 does not change. FIG. 16 illustrates an example in which method 1-2 is applied. Referring to FIG. 16, according to the method 1-2, when TX1 precedes TX2, the total power of TX1 may be lowered and transmitted.

(Method 1-3) For the overlapping N or more slots, the downlink transmission of the DU whose transmission time is later or the uplink transmission of the MT may be transmitted by lowering or dropping the transmission power. That is, for N or more slots of downlink transmission of a following DU or uplink transmission of an MT, for example, reduce transmission power or drop transmission for N or more slots later in time from time y in FIG. 14, it does not affect the transmit power of the preceding MT's uplink transmission or the DU's downlink transmission. That is, according to the method 1-3, the transmission power corresponding to TX1 in FIG. 14 does not change.

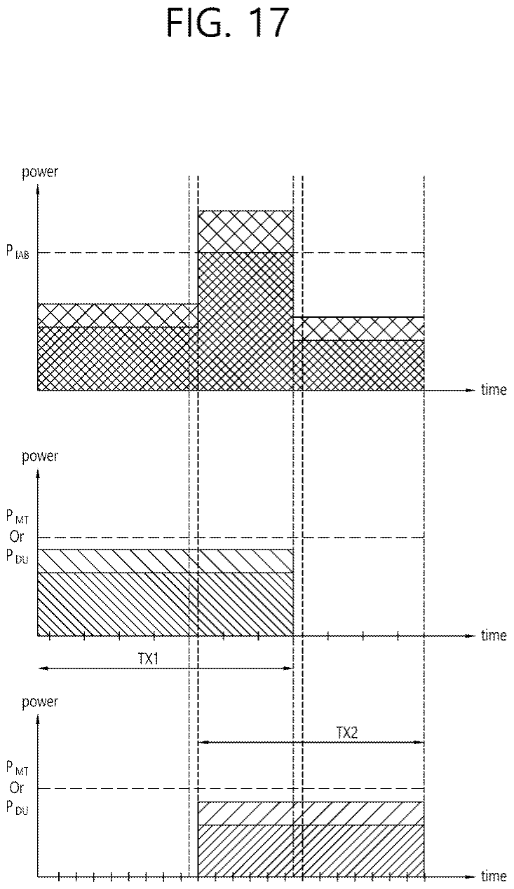

(Method 1-4) For N or more slots in which transmissions overlap, transmit power of both downlink transmission of the DU and uplink transmission of the MT may be reduced or dropped before transmission. That is, referring to FIG. 14, TX1 reduces transmission power or drops transmission for N or more slots preceding in time from time x, TX2 may reduce transmission power or drop transmission for N or more slots later in time from time y. In this case, the level of transmit power may change during transmission of both TX1 and TX2. FIG. 17 shows an example in which the method 1-4 is applied.

Hereinafter, the case of symbol-level overlap will be described.

In the case where the transmission time of a DU or MT overlaps over N (N is 1 or more) symbols of one slot or less, that is, in the case where the sum of powers configured for downlink transmission of DUs and uplink transmissions of MTs exceeds P_{IAB}, the following may be considered.

(Method 2-1) Transmission power of downlink transmission of a DU or uplink transmission of an MT may be lowered or dropped for transmission only for the overlapping N symbols.

(Method 2-2) It is possible to apply methods 1-1 to 1-4 by treating them as overlapping in one slot.

Hereinafter, a transmission power distribution method according to power sharing modes of MTs and DUs will be described.

A semi-static method and a dynamic method may be considered as a power sharing method between the MT and the DU. Semi-static power sharing between MTs and DUs means that the maximum allocatable powers of MTs and DUs do not change instantaneously and are maintained for a certain period of time by assigning a predetermined fixed value to each MT and DU, which is a relationship of P_{MT}+P_{DU}≤P_{IAB}, as configured maximum power. That is, P_{MT} and P_{DU} are allocated in advance and maintained for a certain period of time. At this time, P_{IAB} is transmitted simultaneously by MT and DU in no-TDM relationship due to regulation, etc., this means the maximum usable power or the maximum power notified by the upper layer through MAC-CE or RRC. P_{MT} and P_{DU} mean values obtained by dividing this into MT and DU, respectively, and P_{MT}+P_{DU}=P_{IAB}.

The difference between dynamic power sharing and semi-static power sharing is that the maximum power allocated to MTs and DUs and the time unit for changing P_{MT} and P_{DU} are different. Dynamic power sharing considers power allocation at the slot level, and semi-static power sharing considers power allocation determined by a higher layer through MAC-CE or RRC. In all cases, MTs and DUs are allocated with priority according to the method of describing their respective transmit power, and transmission can be dropped or transmitted with lower transmit power if the transmit power is insufficient.

Hereinafter, semi-static power sharing between MT and DU will be described in detail.

As described above, semi-static power sharing for allocating P_{MT} and P_{DU} in upper layers through MAC-CE, RRC, etc. may consider the following methods. For all methods, when a plurality of slots overlap, an MT or DU that reduces transmit power or drops transmission may lower or drop transmit power for its overlapped slots.

(Method 3-1) PDUs are allocated first, and PMTs are allocated with a value equal to or less than (PIAB−PDU).

For example, when the P_{DU} is smaller than the set power of the MT, power may be allocated according to prioritizations for transmission power reductions of the NR.

As an example, if the P_{DU} is smaller than the set power of the DU, resources treated as hard resources among signals transmitted by DU in the IAB system (e.g., SS/PBCH block, PDCCH for Type0-PDCCH CSS set set by pdcchConfigSIB1, aperiodic CSI-RS, etc.) or among the signals except those restricted so that the power level does not change, depending on the implementation of the IAB node, some of the transmission power may be lowered for transmission or some signals may be dropped to maintain the power level of the transmitted signal.

(Method 3-2) P_{MT} is allocated first, and P_{DU} are allocated with a value equal to or less than (P_{IAB}−P_{MT}).

For example, the P_{DU} may be smaller than the set power of the DU. In this case, the same rule as the case where transmission power of the P_{DU} is insufficient when the P_{DU} is preferentially allocated may be applied.

As an example, the set power of the MT may exceed the P_{MT}. In this case, power may be allocated according to prioritizations for transmission power reductions of NR.

(Method 3-3) The power allocation ratio between the PMT and the PDU may be time-divided and used. That is, the ratio of P_{MT} to P_{DU} may be updated and allocated by RRC, MAC-CE, etc. at predetermined time intervals from a predetermined time point. The start point of power distribution, the values of P_{MT} and P_{DU}, and the time period may be fixed to specific values, set by MAC-CE, RRC, etc., or indicated together when scheduling PUSCH through DCI.

In this case, the DU and MT may perform transmission with power less than or equal to the assigned P_{DU} and P_{MT}, respectively.

Hereinafter, a method for dynamic power sharing between MT and DU will be described in detail.

Dynamic power sharing between MTs and DUs means that the period of maximum transmission power allocation between MTs and DUs is at the slot or symbol level, which can be set by DCI or the like. At this time, the relationship between the transmission maximum power of the MT, DU, and IAB can be considered in three cases.

First, the case of P_{MT}+P_{DU}>P_{IAB} can be considered. That is, since the MT will be defined according to the power class of the UE and the DU according to the power class of the gNB, P_{MT} is the maximum transmit power that the MT can use alone, and P_{DU} is the maximum transmit power that the DU can use alone. However, since the IAB node includes these two, it may be less than the sum of these two due to a new power class or regulation. In this case, when the MT and the DU allocate power based only on their respective maximum transmit power, it is possible to allocate a larger amount of transmit power than the transmit power allowed to the IAB node during simultaneous transmission of the MT and the DU. In this case, one more reduction of transmission power may be required.

Second, the case of P_{MT}+P_{DU}=P_{IAB}, which is the same as the case of semi-static power sharing, can be considered. That is, the maximum transmission power set by the limit of the IAB system is divided into two and allocated to the MT and the DU. This is effective when the MT and the DU perform simultaneous transmission, but when the MT and the DU are configured for simultaneous transmission, but the transmission is dropped due to insufficient transmission power of one, the MT or DU can transmit with less than the maximum transmission power. In order to prevent such a case, “transmission power is allocated with priority” described below means that each MT and DU allocates its own maximum transmit power.

Third, P_{MT} and P_{DU} are determined by regulation or notified by higher layers such as RRC and MAC-CE, so P_{MT} and P_{DU} are not considered, transmission power of MTs and DUs may be allocated according to a power distribution method described below.

On the other hand, assigning priority to transmission power of DUs may mean the following. Hereinafter, the case in which the transmit power of the DU is allocated with priority will be described, if the transmission power of MT has priority, it can be interpreted by replacing DU, MT, P_{DU}, and P_{MT} with MT, DU, P_{MT}, and P_{DU}, respectively, in the description below.

For example, allocating transmission power of DUs with priority may mean allocating maximum P_{DU} and allocating P_{MT} with a value equal to or less than (P_{IAB}−P_{DU}). At this time, the PDU and PMT may be each set to a specific value or less, and this specific value may be defined in advance by a standard or the like or may be a value set by an upper layer. In this case, the DU and MT may perform transmission with power less than or equal to the assigned P_{DU} and P_{MT}, respectively.

As another example, assigning the transmission power of the DU with priority means assigning the transmission power of the DU within a smaller value of P_{DU} or P_{IAB} and P_{DU}, that is, min(P_{IAB}, P_{DU}), the transmission power of the MT may be allocated within min (the difference value between the transmission powers of the P_{IAB} and the DU, P_{MT}). In this case, the P_{DU} and P_{MT} may be values defined by standards or set by higher layers.

In addition to the above examples, preferentially allocating the transmit power of a DU may mean allocating a specific amount of power as needed to the DU first, and allocating the required amount of the remaining power to the MT.

Meanwhile, the following methods are proposed as a method of allocating transmission power of DUs and MTs.

(Method 4-1) Priority can be assigned according to the transmission signals of DUs and MTs. That is, a relatively higher power or maximum power may be allocated to transmission of a signal transmitted by a DU and a signal transmitted by an MT that is set in advance or has a relatively higher priority. This can be applied singly or plural in the following cases.

(Case 1-1) Among the signals transmitted by DUs in the IAB system, resources treated as hard resources (For example, SS/PBCH block, PDCCH for Type0-PDCCH CSS set set by pdcchConfigSIB1, or aperiodic CSI-RS, etc.) may be assigned priority. Here, a resource treated as a hard resource may be a resource that is actually set as a hard resource or may be a resource that is not actually set as a hard resource but is defined in advance by a standard or the like.

(Case 1-2) Priority may be given to signals (e.g., SSB, CSI-RS, etc.) for which the UE expects a constant received power level. Alternatively, with respect to a signal expected to have a constant received power level, a reduced ratio or difference value compared to the existing transmit power of the corresponding signal may be informed. Alternatively, a variable indicating that the received power level expected from the point of view of the terminal has changed may be considered. These ratios, difference values, and change indicator variables may be informed semi-statically through RRC, DCI, or MAC-CE. In this case, the periodic signal may be informed through RRC, the semi-static signal through MAC-CE, and the aperiodic signal through DCI.

(Case 1-3) Signals that do not perform drop during uplink transmission of the MT may be designated in advance and power may be allocated preferentially thereto. For example, a signal including scheduling request (SR), link recovery request (LRR), and HARQ-ACK may be given priority. Alternatively, PRACH may always take precedence.

(Case 1-4) Power may be allocated in preference to reference signals such as DMRS and PTRS. Meanwhile, corresponding data channels such as PUSCH and PDSCH may not have priority in power allocation.

(Method 4-2) Transmission power of MTs and DUs may be allocated in order of time or frequency.

(Case 2-1) Among MTs and DUs, channels for which transmission grants have been received may be allocated in order.

(Case 2-2) Among MTs and DUs, transmission time resources of channels can be allocated in the preceding order. In this case, since transmission timings of MTs and DUs may not match perfectly, respective timings of MTs and DUs may be mapped to a slot level or a symbol level. For example, the i-th slot format index (SFI) of the MT and the j-th SFI of the DU may be treated as the same time.

(Case 2-3) Depending on the signal, priority may be applied in the order of receiving grants or in the order of channel transmission time resources. For example, the PDCCH and PUCCH may be prioritized by determining the time order based on the grant reception time, and the PDSCH and PUSCH based on the time of the channel transmission time resource.

(Case 2-4) Priority may be given according to the transmission frequency. For example, FR1 may take precedence over FR2 or FR2 may take precedence over FR1.

(Method 4-3) Transmission power allocation of MTs and DUs according to buffer conditions may be considered.

(Case 3-1) The amount of information to be transmitted can be assigned to the buffer in the order of increasing number.

(Case 3-2) Priority can be given in the order in which the ratio of the information currently held in the buffer to the buffer capacity is large or small.

(Method 4-4) Priorities of transmission power allocation of MTs and DUs may be time-divided. For example, a timer may be started at the point in time when power is preferentially allocated to the MT, and power may be allocated to the DU with priority when a predetermined time elapses. Here, the start time of the timer may be the exact time when the MT and the DU start overlapping transmission on the time axis, or a symbol or slot including the same. At this time, the timers of MT and DU may be set differently. For example, the ratio of time in which the MT and DU have priority may be maintained for a time determined by the network and updated thereafter. The initial value of this timer may be fixed to a specific value, set by MAC-CE or RRC, or may be set together with indication when scheduling PUSCH through DCI.

(Method 4-5) Depending on the availability information of the resource, for example, information indicating whether a specific resource is hard, soft, NA and/or AI (availability indication) information, it is possible to determine or determine the priority of transmission power allocation of MTs and DUs in a specific time resource. In this case, the resource availability information may be information set to the DU from the CU or donor through the F1-AP. AI information is information indicating availability of soft resources of the DU, and may be transmitted from the parent DU through DCI format 2_5. Depending on the resource availability information and/or AI information, the transmission power allocation priority of MTs and DUs may be determined or determined as follows.

(Case 5-1) In the following resources, transmission power allocation of DUs may take precedence over transmission power allocation of MTs.

For example, the resource may be a resource configured as a hard resource. As another example, the resource may be a soft resource indicated to be usable by DCI format 2_5.

(Case 5-2) In the following resources, transmission power allocation of DUs may take precedence over transmission power allocation of MTs.

As an example, the resource may be a resource set to NA. As another example, it may be a soft resource not indicated to be usable by DCI format 2_5.

Hereinafter, a case in which MT and/or DU drop transmission will be described in detail.

When transmission power of an MT or DU is allocated according to the above-described method, a signal that is dropped due to priority or lack of transmission power may drop transmission according to the following four cases.

(Case 1) When the uplink transmission of the MT needs to be dropped, the following example can be considered as a point of time when this is recognized. Here, the time point at which the drop is recognized may be a time point at which it is recognized that adjustment/control of the transmission power described in this specification is necessary. For example, the time at which the drop is recognized may be a time at which a new transmission operation requiring a change in transmission power for a transmission operation previously scheduled by semi-static scheduling is scheduled.

For example, if the parent node does not recognize the drop N unit time before the MT needs to drop the uplink transmission, the MT may puncture the entire slot overlapped with the downlink transmission of the DU, or the MT may puncture only the OFDM symbol resource for performing the downlink transmission of the DU.

As another example, if the parent node can recognize the drop N units of time before the MT needs to drop the uplink transmission, if it overlaps with the downlink transmission of cell-specific DUs (e.g., SSB/PBCH block, periodic/semi-static CSI-RS, etc.), and the downlink signals of these DUs have priority in power allocation, the parent node can know in advance resource information on which downlink transmission of such a DU is performed. In this case, when performing uplink transmission, the MT may exclude and transmit resources overlapping with downlink transmission of these DUs, for example, overlapping OFDM symbol regions through rate-matching. In this case, when the MT transmits a specific uplink signal, for example, PRACH on PCell, PUCCH including SR/LRR, etc., rate-matching may be performed except for transmission resources of the uplink signal of the MT, for example, OFDM symbols including transmission resources.

(Case 2) When the downlink transmission of the DU needs to be dropped, the following example may be considered based on the time point at which it is recognized.

For example, if the parent node does not recognize the drop N unit time before the drop of the downlink transmission of the DU is required, the DU may puncture the entire slot overlapped with the uplink transmission of the MT, or the DU may puncture only the OFDM symbol resource for performing the uplink transmission of the MT.

As another example, if the parent node recognizes the drop N units of time before the drop of the downlink transmission of the DU is required, if it overlaps with a specific uplink signal of the MT, for example, PRACH on PCell, PUCCH including SR/LRR, etc., the overlapping part with the downlink transmission of the DU may be excluded through rate-matching and transmitted. In this case, rate-matching may be performed except for cell-specific signals of downlink transmission of the DU, for example, signals such as SSB/PBCH block and periodic/semi-static CSI-RS.

(Case 3) In the case where a channel or signal that cannot be dropped between a DU and an MT needs to be dropped, the following example can be considered.

For example, it may be determined according to the implementation of the IAB system. As another example, downlink transmission of DUs may be performed first, and uplink transmissions of MTs may be dropped. As another example, transmission may be performed according to the availability of DU and MT resources (i.e., hard, soft, NA) and AI-DCI settings. That is, in the case of hard resources, MT transmission is dropped, and in the case of NA resources, DU transmission is dropped, in the case of soft resources, MT transmission may be dropped when AI-DCI is indicated, and DU transmission may be dropped when AI-DCI is not indicated.

(Case 4) When both the DU and the MT need to transmit channels or signals capable of being dropped, the same operation as in Case 3 described above can be performed.

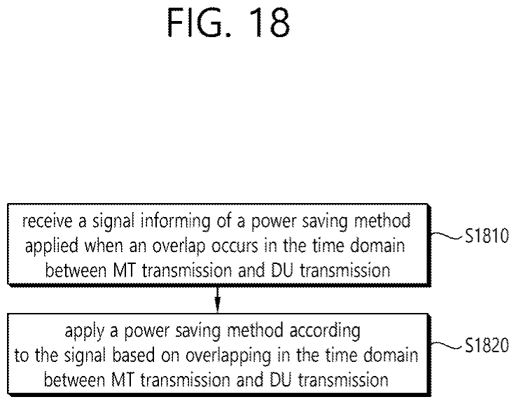

FIG. 18 is a flowchart of an example of a method for power control of an IAB node according to some implementations herein.

Referring to FIG. 18, the IAB node receives a signal informing of a power saving method applied when an overlap occurs in the time domain between MT transmission and DU transmission (S1810).

Thereafter, the IAB node applies a power saving method according to the signal based on overlapping in the time domain between MT transmission and DU transmission (S1820).

Referring to FIG. 18, the IAB node may receive a signal indicating a power saving method to be applied when temporal overlap occurs between MT transmission and DU transmission from the parent node or network. The IAB node may apply a power saving method according to the signal when temporal overlap occurs between MT transmission and DU transmission. For example, the signal may indicate at least one of the power saving methods described herein, the IAB node may apply the power saving method indicated by the signal when temporal overlap occurs between MT transmission and DU transmission.

Or, unlike the example of FIG. 18, when the IAB node temporally overlaps between MT transmission and DU transmission, if overlapping of the slots/symbols described in this specification occurs without an explicit signal indicating the power saving method to be applied, the related power saving method may be applied.

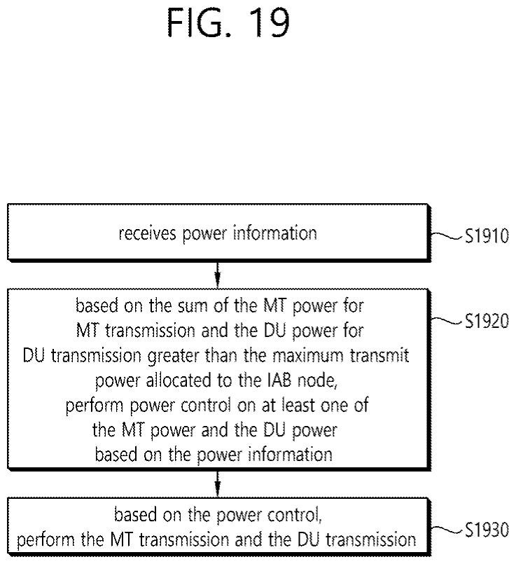

FIG. 19 is a flow chart of another example of a method for controlling power of an IAB node according to some implementations of the present disclosure.

Referring to FIG. 19, the IAB node receives power information (S1910). Here, the power information may inform the IAB node of a set power control method.

Then, based on the sum of the MT power for MT transmission and the DU power for DU transmission greater than the maximum transmit power allocated to the IAB node, the IAB node performs power control on at least one of the MT power and the DU power based on the power information (S1920).

Then, based on the power control, the IAB node performs the MT transmission and the DU transmission (S1930).

Here, the MT transmission may be transmission for a parent node of the IAB node, and the DU transmission may be transmission for a child node of the IAB node. Also, here, the MT resource on which the MT transmission is performed and the DU resource on which the DU transmission is performed may overlap in the time domain.

The methods proposed in this specification may be performed by at least one computer readable medium comprising instructions to be executed by at least one processor, and an apparatus set up to control IAB nodes comprising one or more processors and one or more memories executable connected by the one or more processors and storing instructions, where the one or more processors execute the instructions to perform the methods proposed herein, in addition to the IAB node. In addition, according to the methods proposed in this specification, it is obvious that an operation by another IAB node corresponding to an operation performed by an IAB node can be considered.

Hereinafter, an example of a communication system to which the disclosure is applied is described.

Various descriptions, functions, procedures, proposals, methods, and/or operational flowcharts disclosed herein may be applied to, but not limited to, various fields requiring wireless communication/connection (e.g., 5G) between devices.

Hereinafter, specific examples are illustrated with reference to drawings. In the following drawings/description, unless otherwise indicated, like reference numerals may refer to like or corresponding hardware blocks, software blocks, or functional blocks.

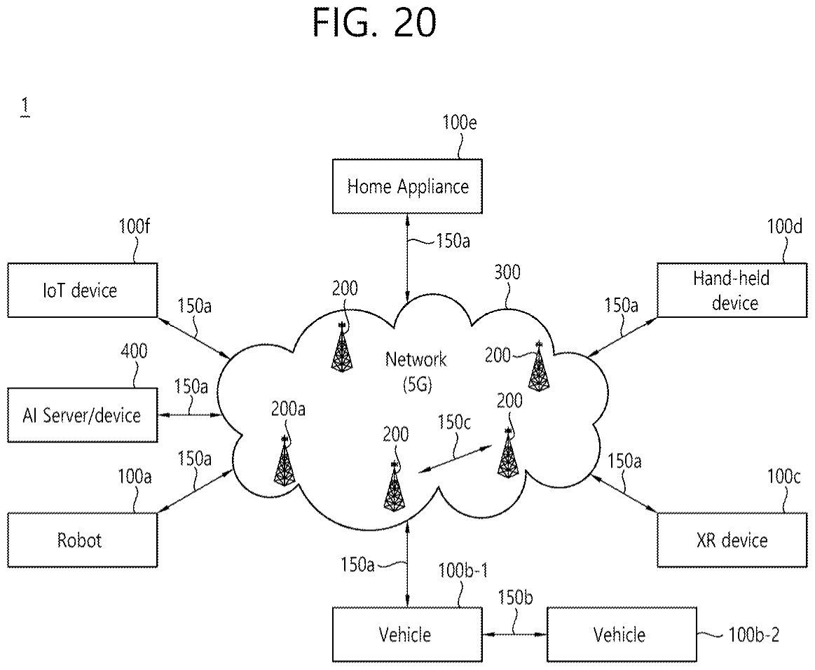

FIG. 20 illustrates a communication system 1 applied to the disclosure.

Referring to FIG. 20, the communication system 1 applied to the disclosure includes a wireless device, a base station, and a network. Here, the wireless device refers to a device that performs communication using a radio access technology (e.g., 5G new RAT (NR) or Long-Term Evolution (LTE)) and may be referred to as a communication/wireless/5G device. The wireless device may include, but limited to, a robot 100a, a vehicle 100b-1 and 100b-2, an extended reality (XR) device 100c, a hand-held device 100d, a home appliance 100e, an Internet of things (IoT) device 100f, and an AI device/server 400. For example, the vehicle may include a vehicle having a wireless communication function, an autonomous driving vehicle, a vehicle capable of inter-vehicle communication, or the like. Here, the vehicle may include an unmanned aerial vehicle (UAV) (e.g., a drone). The XR device may include augmented reality (AR)/virtual reality (VR)/mixed reality (MR) devices and may be configured as a head-mounted device (HMD), a vehicular head-up display (HUD), a television, a smartphone, a computer, a wearable device, a home appliance, digital signage, a vehicle, a robot, or the like. The hand-held device may include a smartphone, a smartpad, a wearable device (e.g., a smart watch or smart glasses), and a computer (e.g., a notebook). The home appliance may include a TV, a refrigerator, a washing machine, and the like. The IoT device may include a sensor, a smart meter, and the like. The base station and the network may be configured, for example, as wireless devices, and a specific wireless device 200a may operate as a base station/network node for other wireless devices.

Here, the wireless communication technology implemented in the wireless device of the present disclosure may include a narrowband Internet of Things for low-power communication as well as LTE, NR, and 6G. At this time, for example, NB-IoT technology may be an example of low power wide area network (LPWAN) technology, and may be implemented in standards such as LTE Cat NB1 and/or LTE Cat NB2, may be implemented in the standard of LTE Cat NB1 and/or LTE Cat NB2, and is not limited to the names mentioned above. Additionally or alternatively, the wireless communication technology implemented in the wireless device of the present disclosure may perform communication based on LTE-M technology. In this case, as an example, the LTE-M technology may be an example of an LPWAN technology, and may be called by various names such as enhanced machine type communication (eMTC). For example, LTE-M technology may be implemented by at least any one of various standards such as 1) LTE CAT 0, 2) LTE Cat M1, 3) LTE Cat M2, 4) LTE non-BL (non-Bandwidth Limited), 5) LTE-MTC, 6) LTE Machine Type Communication, and/or 7) LTE M, and is not limited to the names described above. Additionally or alternatively, the wireless communication technology implemented in the wireless device of the present disclosure may include at least one of ZigBee, Bluetooth, and LPWAN considering low power communication and is not limited to the names described above. For example, the ZigBee technology may create personal area networks (PAN) related to small/low-power digital communication based on various standards such as IEEE 802.15.4, and may be called by various names.

The wireless devices 100a to 100f may be connected to the network 300 through the base station 200. Artificial intelligence (AI) technology may be applied to the wireless devices 100a to 100f, and the wireless devices 100a to 100f may be connected to an AI server 400 through the network 300. The network 300 may be configured using a 3G network, a 4G (e.g., LTE) network, or a 5G (e.g., NR) network. The wireless devices 100a to 100f may communicate with each other via the base station 200/network 300 and may also perform direct communication (e.g. sidelink communication) with each other without passing through the base station/network. For example, the vehicles 100b-1 and 100b-2 may perform direct communication (e.g. vehicle-to-vehicle (V2V)/vehicle-to-everything (V2X) communication). Further, the IoT device (e.g., a sensor) may directly communicate with another IoT device (e.g., a sensor) or another wireless device 100a to 100f.

Wireless communications/connections 150a, 150b, and 150c may be established between the wireless devices 100a to 100f and the base station 200 and between the base stations 200. Here, the wireless communications/connections may be established by various wireless access technologies (e.g., 5G NR), such as uplink/downlink communication 150a, sidelink communication 150b (or D2D communication), and inter-base station communication 150c (e.g., relay or integrated access backhaul (IAB)). The wireless devices and the base station/wireless devices, and the base stations may transmit/receive radio signals to/from each other through the wireless communications/connections 150a, 150b, and 150c. For example, the wireless communications/connections 150a, 150b, and 150c may transmit/receive signals over various physical channels. To this end, at least some of various configuration information setting processes, various signal processing processes (e.g., channel encoding/decoding, modulation/demodulation, resource mapping/demapping, and the like), and resource allocation processes may be performed on the basis of various proposals of the disclosure.

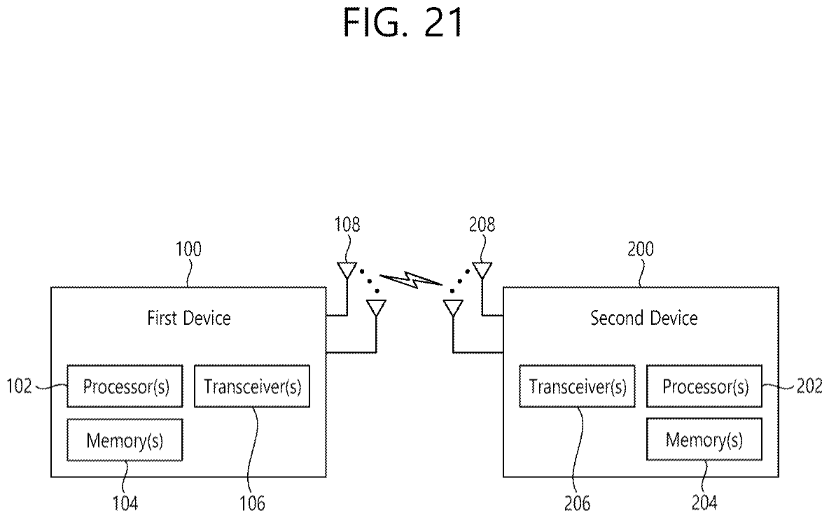

FIG. 21 illustrates a wireless device that is applicable to the disclosure.

Referring to FIG. 21, a first wireless device 100 and a second wireless device 200 may transmit and receive radio signals through various radio access technologies (e.g., LTE and NR). Here, the first wireless device 100 and the second wireless device 200 may respectively correspond to a wireless device 100x and the base station 200 of FIG. 20 and/or may respectively correspond to a wireless device 100x and a wireless device 100x of FIG. 20.

The first wireless device 100 includes at least one processor 102 and at least one memory 104 and may further include at least one transceiver 106 and/or at least one antenna 108. The processor 102 may be configured to control the memory 104 and/or the transceiver 106 and to implement the descriptions, functions, procedures, proposals, methods, and/or operational flowcharts disclosed herein. For example, the processor 102 may process information in the memory 104 to generate first information/signal and may then transmit a radio signal including the first information/signal through the transceiver 106. In addition, the processor 102 may receive a radio signal including second information/signal through the transceiver 106 and may store information obtained from signal processing of the second information/signal in the memory 104. The memory 104 may be connected to the processor 102 and may store various pieces of information related to the operation of the processor 102. For example, the memory 104 may store a software code including instructions to perform some or all of processes controlled by the processor 102 or to perform the descriptions, functions, procedures, proposals, methods, and/or operational flowcharts disclosed herein. Here, the processor 102 and the memory 104 may be part of a communication modem/circuit/chip designed to implement a radio communication technology (e.g., LTE or NR). The transceiver 106 may be connected with the processor 102 and may transmit and/or receive a radio signal via the at least one antennas 108. The transceiver 106 may include a transmitter and/or a receiver. The transceiver 106 may be replaced with a radio frequency (RF) unit. In the disclosure, the wireless device may refer to a communication modem/circuit/chip.

The second wireless device 200 includes at least one processor 202 and at least one memory 204 and may further include at least one transceiver 206 and/or at least one antenna 208. The processor 202 may be configured to control the memory 204 and/or the transceiver 206 and to implement the descriptions, functions, procedures, proposals, methods, and/or operational flowcharts disclosed herein. For example, the processor 202 may process information in the memory 204 to generate third information/signal and may then transmit a radio signal including the third information/signal through the transceiver 206. In addition, the processor 202 may receive a radio signal including fourth information/signal through the transceiver 206 and may store information obtained from signal processing of the fourth information/signal in the memory 204. The memory 204 may be connected to the processor 202 and may store various pieces of information related to the operation of the processor 202. For example, the memory 204 may store a software code including instructions to perform some or all of processes controlled by the processor 202 or to perform the descriptions, functions, procedures, proposals, methods, and/or operational flowcharts disclosed herein. Here, the processor 202 and the memory 204 may be part of a communication modem/circuit/chip designed to implement a radio communication technology (e.g., LTE or NR). The transceiver 206 may be connected with the processor 202 and may transmit and/or receive a radio signal via the at least one antennas 208. The transceiver 206 may include a transmitter and/or a receiver. The transceiver 206 may be replaced with an RF unit. In the disclosure, the wireless device may refer to a communication modem/circuit/chip.

Hereinafter, hardware elements of the wireless devices 100 and 200 are described in detail. At least one protocol layer may be implemented, but limited to, by the at least one processor 102 and 202. For example, the at least one processor 102 and 202 may implement at least one layer (e.g., a functional layer, such as PHY, MAC, RLC, PDCP, RRC, and SDAP layers). The at least one processor 102 and 202 may generate at least one protocol data unit (PDU) and/or at least one service data unit (SDU) according to the descriptions, functions, procedures, proposals, methods, and/or operational flowcharts disclosed herein. The at least one processor 102 and 202 may generate a message, control information, data, or information according to the descriptions, functions, procedures, proposals, methods, and/or operational flowcharts disclosed herein. The at least one processor 102 and 202 may generate a signal (e.g., a baseband signal) including a PDU, an SDU, a message, control information, data, or information according to the functions, procedures, proposals, and/or methods disclosed herein and may provide the signal to the at least one transceiver 106 and 206. The at least one processor 102 and 202 may receive a signal (e.g., a baseband signal) from the at least one transceiver 106 and 206 and may obtain a PDU, an SDU, a message, control information, data, or information according to the descriptions, functions, procedures, proposals, methods, and/or operational flowcharts disclosed herein.

The at least one processor 102 and 202 may be referred to as a controller, a microcontroller, a microprocessor, or a microcomputer. The at least one processor 102 and 202 may be implemented by hardware, firmware, software, or a combination thereof. For example, at least one application-specific integrated circuit (ASIC), at least one digital signal processor (DSP), at least one digital signal processing devices (DSPD), at least one programmable logic devices (PLD), or at least one field programmable gate array (FPGA) may be included in the at least one processor 102 and 202. The descriptions, functions, procedures, proposals, methods, and/or operational flowcharts disclosed herein may be implemented using firmware or software, and the firmware or software may be configured to include modules, procedures, functions, and the like. The firmware or software configured to perform the descriptions, functions, procedures, proposals, methods, and/or operational flowcharts disclosed herein may be included in the at least one processor 102 and 202 or may be stored in the at least one memory 104 and 204 and may be executed by the at least one processor 102 and 202. The descriptions, functions, procedures, proposals, methods, and/or operational flowcharts disclosed herein may be implemented in the form of a code, an instruction, and/or a set of instructions using firmware or software.

The at least one memory 104 and 204 may be connected to the at least one processor 102 and 202 and may store various forms of data, signals, messages, information, programs, codes, indications, and/or commands. The at least one memory 104 and 204 may be configured as a ROM, a RAM, an EPROM, a flash memory, a hard drive, a register, a cache memory, a computer-readable storage medium, and/or a combinations thereof. The at least one memory 104 and 204 may be disposed inside and/or outside the at least one processor 102 and 202. In addition, the at least one memory 104 and 204 may be connected to the at least one processor 102 and 202 through various techniques, such as a wired or wireless connection.

The at least one transceiver 106 and 206 may transmit user data, control information, a radio signal/channel, or the like mentioned in the methods and/or operational flowcharts disclosed herein to at least different device. The at least one transceiver 106 and 206 may receive user data, control information, a radio signal/channel, or the like mentioned in the descriptions, functions, procedures, proposals, methods, and/or operational flowcharts disclosed herein from at least one different device. For example, the at least one transceiver 106 and 206 may be connected to the at least one processor 102 and 202 and may transmit and receive a radio signal. For example, the at least one processor 102 and 202 may control the at least one transceiver 106 and 206 to transmit user data, control information, or a radio signal to at least one different device. In addition, the at least one processor 102 and 202 may control the at least one transceiver 106 and 206 to receive user data, control information, or a radio signal from at least one different device. The at least one transceiver 106 and 206 may be connected to the at least one antenna 108 and 208 and may be configured to transmit or receive user data, control information, a radio signal/channel, or the like mentioned in the descriptions, functions, procedures, proposals, methods, and/or operational flowcharts disclosed herein through the at least one antenna 108 and 208. In this document, the at least one antenna may be a plurality of physical antennas or may be a plurality of logical antennas (e.g., antenna ports). The at least one transceiver 106 and 206 may convert a received radio signal/channel from an RF band signal into a baseband signal in order to process received user data, control information, a radio signal/channel, or the like using the at least one processor 102 and 202. The at least one transceiver 106 and 206 may convert user data, control information, a radio signal/channel, or the like, processed using the at least one processor 102 and 202, from a baseband signal to an RF bad signal. To this end, the at least one transceiver 106 and 206 may include an (analog) oscillator and/or a filter.

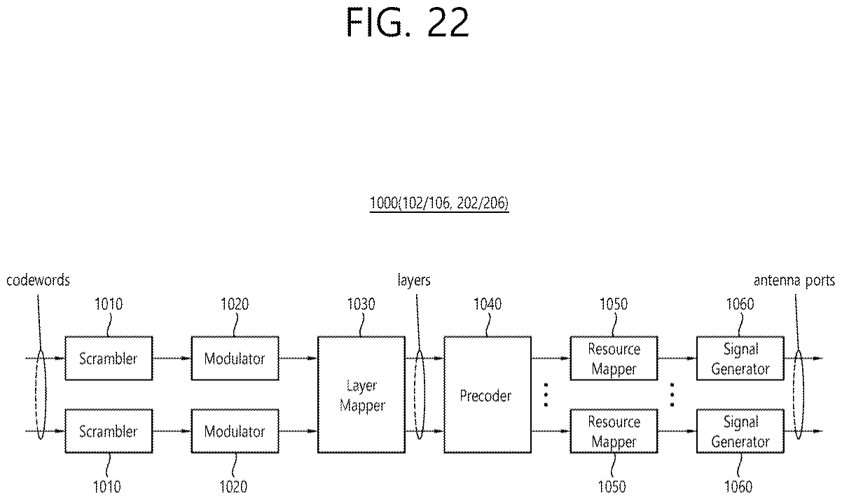

FIG. 22 illustrates a signal processing circuit for a transmission signal.

Referring to FIG. 22, the signal processing circuit 1000 may include a scrambler 1010, a modulator 1020, a layer mapper 1030, a precoder 1040, a resource mapper 1050, and a signal generator 1060. Operations/functions illustrated with reference to FIG. 22 may be performed, but not limited to, in the processor 102 and 202 and/or the transceiver 106 and 206 of FIG. 21. Hardware elements illustrated in FIG. 22 may be configured in the processor 102 and 202 and/or the transceiver 106 and 206 of FIG. 21. For example, blocks 1010 to 1060 may be configured in the processor 102 and 202 of FIG. 21. Alternatively, blocks 1010 to 1050 may be configured in the processor 102 and 202 of FIG. 21, and a block 1060 may be configured in the transceiver 106 and 206 of FIG. 21.

A codeword may be converted into a radio signal via the signal processing circuit 1000 of FIG. 22. Here, the codeword is an encoded bit sequence of an information block. The information block may include a transport block (e.g., a UL-SCH transport block and a DL-SCH transport block). The radio signal may be transmitted through various physical channels (e.g., a PUSCH or a PDSCH).

Specifically, the codeword may be converted into a scrambled bit sequence by the scrambler 1010. A scrambled sequence used for scrambling is generated on the basis of an initialization value, and the initialization value may include ID information about a wireless device. The scrambled bit sequence may be modulated into a modulation symbol sequence by the modulator 1020. A modulation scheme may include pi/2-binary phase shift keying (pi/2-BPSK), m-phase shift keying (m-PSK), m-quadrature amplitude modulation (m-QAM), and the like. A complex modulation symbol sequence may be mapped to at least one transport layer by the layer mapper 1030. Modulation symbols of each transport layer may be mapped to a corresponding antenna port(s) by the precoder 1040 (precoding). Output z from the precoder 1040 may be obtained by multiplying output y from the layer mapper 1030 by a precoding matrix W of N*M, where N is the number of antenna ports, and M is the number of transport layers. Here, the precoder 1040 may perform precoding after performing transform precoding (e.g., DFT transform) on complex modulation symbols. Alternatively, the precoder 1040 may perform precoding without performing transform precoding.

The resource mapper 1050 may map a modulation symbol of each antenna port to a time-frequency resource. The time-frequency resource may include a plurality of symbols (e.g., CP-OFDMA symbols or DFT-s-OFDMA symbols) in the time domain and may include a plurality of subcarriers in the frequency domain. The signal generator 1060 may generate a radio signal from mapped modulation symbols, and the generated radio signal may be transmitted to another device through each antenna. To this end, the signal generator 1060 may include an inverse fast Fourier transform (IFFT) module, a cyclic prefix (CP) inserter, a digital-to-analog converter (DAC), a frequency upconverter, and the like.

A signal processing procedure for a received signal in a wireless device may be performed in the reverse order of the signal processing procedure 1010 to 1060 of FIG. 22. For example, a wireless device (e.g., 100 and 200 of FIG. 21) may receive a radio signal from the outside through an antenna port/transceiver. The received radio signal may be converted into a baseband signal through a signal reconstructor. To this end, the signal reconstructor may include a frequency downconverter, an analog-to-digital converter (ADC), a CP remover, and a fast Fourier transform (FFT) module. The baseband signal may be reconstructed to a codeword through resource demapping, postcoding, demodulation, and descrambling. The codeword may be reconstructed to an original information block through decoding. Thus, a signal processing circuit (not shown) for a received signal may include a signal reconstructor, a resource demapper, a postcoder, a demodulator, a descrambler and a decoder.

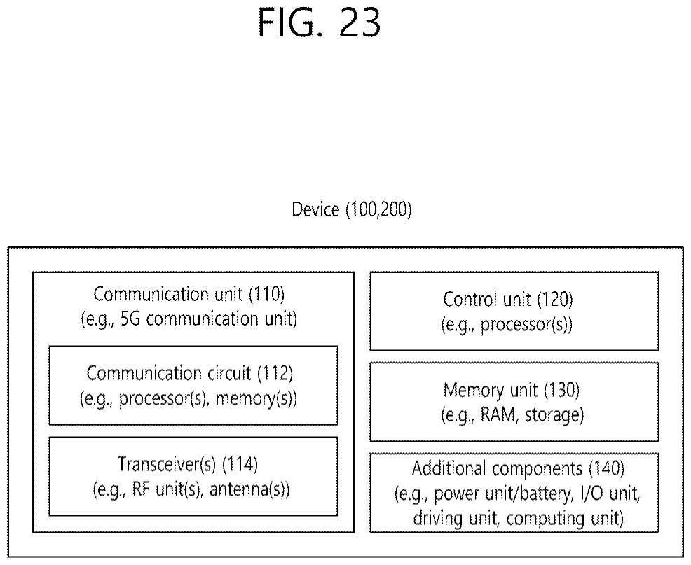

FIG. 23 illustrates another example of a wireless device applied to the disclosure. The wireless device may be configured in various forms depending on usage/service.

Referring to FIG. 23, the wireless devices 100 and 200 may correspond to the wireless device 100 and 200 of FIG. 21 and may include various elements, components, units, and/or modules. For example, the wireless device 100 and 200 may include a communication unit 110, a control unit 120, a memory unit 130, and additional components 140. The communication unit may include a communication circuit 112 and a transceiver(s) 114. For example, the communication circuit 112 may include the at least one processor 102 and 202 and/or the at least one memory 104 and 204 of FIG. 21. For example, the transceiver(s) 114 may include the at least one transceiver 106 and 206 and/or the at least one antenna 108 and 208 of FIG. 21. The control unit 120 is electrically connected to the communication unit 110, the memory unit 130, and the additional components 140 and controls overall operations of the wireless device. For example, the control unit 120 may control electrical/mechanical operations of the wireless device on the basis of a program/code/command/information stored in the memory unit 130. In addition, the control unit 120 may transmit information stored in the memory unit 130 to the outside (e.g., a different communication device) through a wireless/wired interface via the communication unit 110 or may store, in the memory unit 130, information received from the outside (e.g., a different communication device) through the wireless/wired interface via the communication unit 110.

The additional components 140 may be configured variously depending on the type of the wireless device. For example, the additional components 140 may include at least one of a power unit/battery, an input/output (I/O) unit, a driving unit, and a computing unit. The wireless device may be configured, but not limited to, as a robot (100a in FIG. 20), a vehicle (100b-1 or 100b-2 in FIG. 20), an XR device (100c in FIG. 20), a hand-held device (100d in FIG. 20), a home appliance (100e in FIG. 20), an IoT device (100f in FIG. 20), a terminal for digital broadcasting, a hologram device, a public safety device, an MTC device, a medical device, a fintech device (or financial device), a security device, a climate/environmental device, an AI server/device (400 in FIG. 20), a base station (200 in FIG. 20), a network node, or the like. The wireless device may be mobile or may be used in a fixed place depending on usage/service.

In FIG. 23, all of the various elements, components, units, and/or modules in the wireless devices 100 and 200 may be connected to each other through a wired interface, or at least some thereof may be wirelessly connected through the communication unit 110. For example, the control unit 120 and the communication unit 110 may be connected via a cable in the wireless device 100 and 200, and the control unit 120 and a first unit (e.g., 130 and 140) may be wirelessly connected through the communication unit 110. In addition, each element, component, unit, and/or module in wireless device 100 and 200 may further include at least one element. For example, the control unit 120 may include at least one processor set. For example, the control unit 120 may be configured as a set of a communication control processor, an application processor, an electronic control unit (ECU), a graphics processing processor, a memory control processor, and the like. In another example, the memory unit 130 may include a random-access memory (RAM), a dynamic RAM (DRAM), a read-only memory (ROM), a flash memory, a volatile memory, a non-volatile memory, and/or a combination thereof.

Next, an illustrative configuration of FIG. 23 is described in detail with reference to the accompanying drawing.

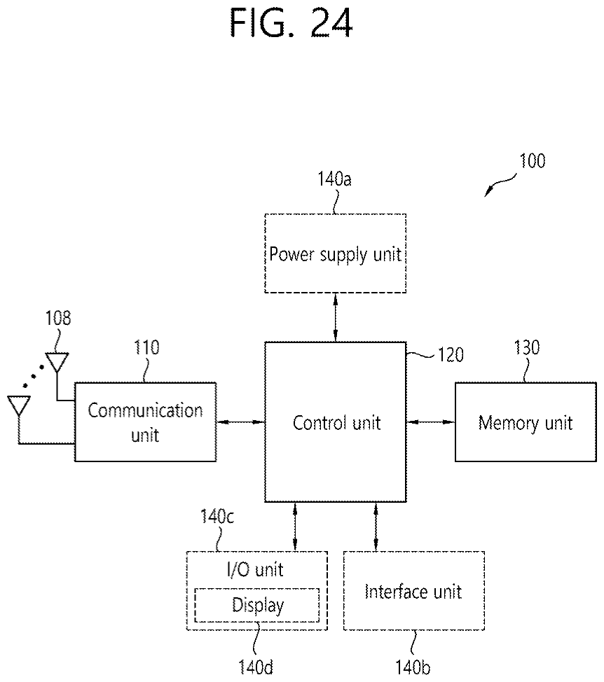

FIG. 24 illustrates a hand-held device applied to the disclosure. The hand-held device may include a smartphone, a smartpad, a wearable device (e.g., a smart watch or smart glasses), and a portable computer (e.g., a notebook). The hand-held device may be referred to as a mobile station (MS), a user terminal (UT), a mobile subscriber station (MSS), a subscriber station (SS), an advanced mobile station (AMS), or a wireless terminal (WT).

Referring to FIG. 24, the hand-held device 100 may include an antenna unit 108, a communication unit 110, a control unit 120, a memory unit 130, a power supply unit 140a, an interface unit 140b, and an input/output unit 140c. The antenna unit 108 may be configured as a part of the communication unit 110. Blocks 110 to 130/140a to 140c correspond to the blocks 110 to 130/140 in FIG. 23, respectively.

The communication unit 110 may transmit and receive a signal (e.g., data, a control signal, or the like) to and from other wireless devices and base stations. The control unit 120 may control various components of the hand-held device 100 to perform various operations. The control unit 120 may include an application processor (AP). The memory unit 130 may store data/parameter/program/code/command necessary to drive the hand-held device 100. Further, the memory unit 130 may store input/output data/information. The power supply unit 140a supplies power to the hand-held device 100 and may include a wired/wireless charging circuit, a battery, and the like. The interface unit 140b may support a connection between the hand-held device 100 and a different external device. The interface unit 140b may include various ports (e.g., an audio input/output port and a video input/output port) for connection to an external device. The input/output unit 140c may receive or output image information/signal, audio information/signal, data, and/or information input from a user. The input/output unit 140c may include a camera, a microphone, a user input unit, a display unit 140d, a speaker, and/or a haptic module.

For example, in data communication, the input/output unit 140c may obtain information/signal (e.g., a touch, text, voice, an image, and a video) input from the user, and the obtained information/signal may be stored in the memory unit 130. The communication unit 110 may convert information/signal stored in the memory unit into a radio signal and may transmit the converted radio signal directly to a different wireless device or to a base station. In addition, the communication unit 110 may receive a radio signal from a different wireless device or the base station and may reconstruct the received radio signal to original information/signal. The reconstructed information/signal may be stored in the memory unit 130 and may then be output in various forms (e.g., text, voice, an image, a video, and a haptic form) through the input/output unit 140c.

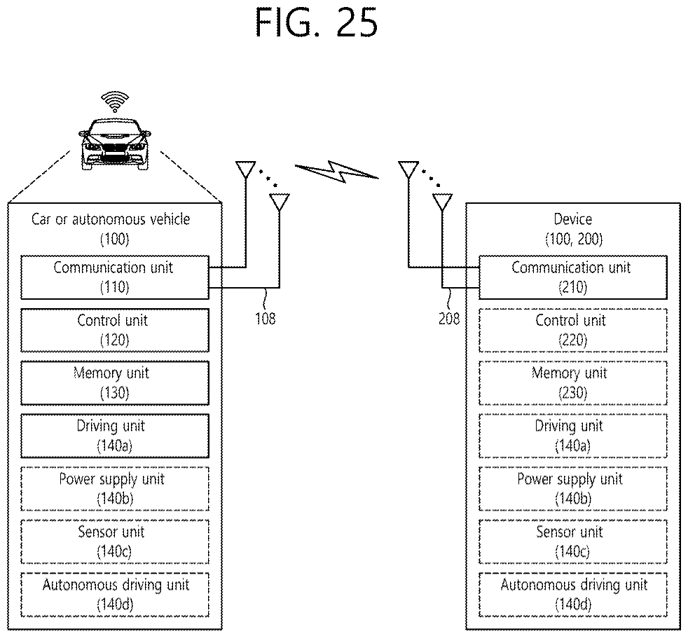

FIG. 25 illustrates a vehicle or an autonomous driving vehicle applied to the disclosure. The vehicle or the autonomous driving may be configured as a mobile robot, a car, a train, a manned/unmanned aerial vehicle (AV), a ship, or the like.

Referring to FIG. 25, the vehicle or the autonomous driving vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110. Blocks 110/130/140a to 140d correspond to the blocks 110/130/140 in FIG. 23, respectively.

The communication unit 110 may transmit and receive a signal (e.g., data, a control signal, or the like) to and from external devices, such as a different vehicle, a base station (e.g. a base station, a road-side unit, or the like), and a server. The control unit 120 may control elements of the vehicle or the autonomous driving vehicle 100 to perform various operations. The control unit 120 may include an electronic control unit (ECU). The driving unit 140a may enable the vehicle or the autonomous driving vehicle 100 to run on the ground. The driving unit 140a may include an engine, a motor, a power train, wheels, a brake, a steering device, and the like. The power supply unit 140b supplies power to the vehicle or the autonomous driving vehicle 100 and may include a wired/wireless charging circuit, a battery, and the like. The sensor unit 140c may obtain a vehicle condition, environmental information, user information, and the like. The sensor unit 140c may include an inertial measurement unit (IMU) sensor, a collision sensor, a wheel sensor, a speed sensor, an inclination sensor, a weight sensor, a heading sensor, a position module, vehicular forward/backward vision sensors, a battery sensor, a fuel sensor, a tire sensor, a steering sensor, a temperature sensor, a humidity sensor, an ultrasonic sensor, an illuminance sensor, a pedal position sensor, and the like. The autonomous driving unit 140d may implement a technology for maintaining a driving lane, a technology for automatically adjusting speed, such as adaptive cruise control, a technology for automatic driving along a set route, a technology for automatically setting a route and driving when a destination is set, and the like.

For example, the communication unit 110 may receive map data, traffic condition data, and the like from an external server. The autonomous driving unit 140d may generate an autonomous driving route and a driving plan on the basis of obtained data. The control unit 120 may control the driving unit 140a to move the vehicle or the autonomous driving vehicle 100 along the autonomous driving route according to the driving plan (e.g., speed/direction control). During autonomous driving, the communication unit 110 may aperiodically/periodically obtain updated traffic condition data from the external server and may obtain surrounding traffic condition data from a neighboring vehicle. Further, during autonomous driving, the sensor unit 140c may obtain a vehicle condition and environmental information. The autonomous driving unit 140d may update the autonomous driving route and the driving plan on the basis of newly obtained data/information. The communication unit 110 may transmit information about a vehicle location, an autonomous driving route, a driving plan, and the like to the external server. The external server may predict traffic condition data in advance using AI technology or the like on the basis of information collected from vehicles or autonomous driving vehicles and may provide the predicted traffic condition data to the vehicles or the autonomous driving vehicles.

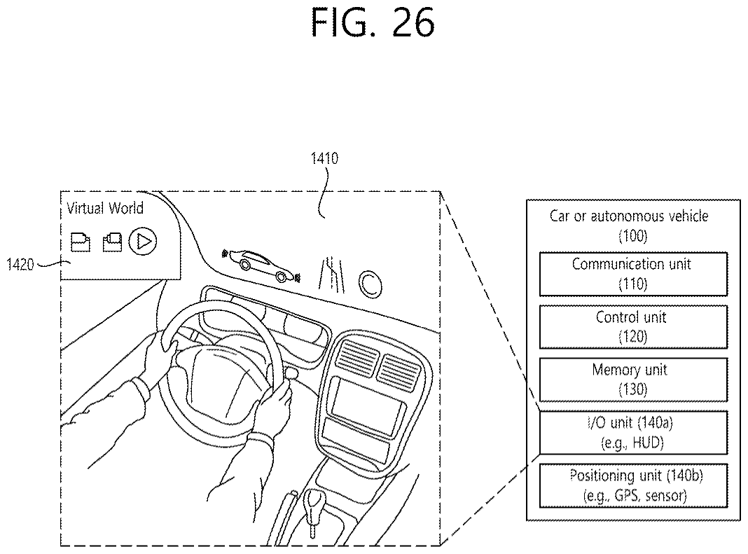

FIG. 26 illustrates a vehicle applied to the disclosure. The vehicle may be implemented as a means of transportation, a train, an air vehicle, a ship, and the like.

Referring to FIG. 26, the vehicle 100 may include a communication unit 110, a control unit 120, a memory unit 130, an input/output unit 140a, and a positioning unit 140b. Herein, blocks 110 to 130/140a to 140b correspond to block 110 to 130/140 of FIG. 23, respectively.

The communication unit 110 may transmit/receive signals (e.g., data, control signals, etc.) with other vehicles or external devices such as a base station. The control unit 120 may control components of the vehicle 100 to perform various operations. The memory unit 130 may store data/parameters/programs/codes/commands supporting various functions of the vehicle 100. The input/output unit 140a may output an AR/VR object based on information in the memory unit 130. The input/output unit 140a may include a HUD. The positioning unit 140b may acquire position information of the vehicle 100. The location information may include absolute location information of the vehicle 100, location information within a driving line, acceleration information, location information with a neighboring vehicle, and the like. The positioning unit 140b may include a GPS and various sensors.

For example, the communication unit 110 of the vehicle 100 may receive map information, traffic information, and the like from an external server and store it in the memory unit 130. The positioning unit 140b may obtain vehicle position information through GPS and various sensors and store it in the memory unit 130. The control unit 120 may generate a virtual object based on map information, traffic information, vehicle location information, and the like, and the input/output unit 140a may display the generated virtual object on a window inside the vehicle (1410 and 1420). In addition, the control unit 120 may determine whether the vehicle 100 is normally operating within the driving line based on the vehicle location information. When the vehicle 100 abnormally deviates from the driving line, the control unit 120 may display a warning on the windshield of the vehicle through the input/output unit 140a. Also, the control unit 120 may broadcast a warning message regarding the driving abnormality to surrounding vehicles through the communication unit 110. Depending on the situation, the control unit 120 may transmit the location information of the vehicle and information on driving/vehicle abnormality to the related organization through the communication unit 110.

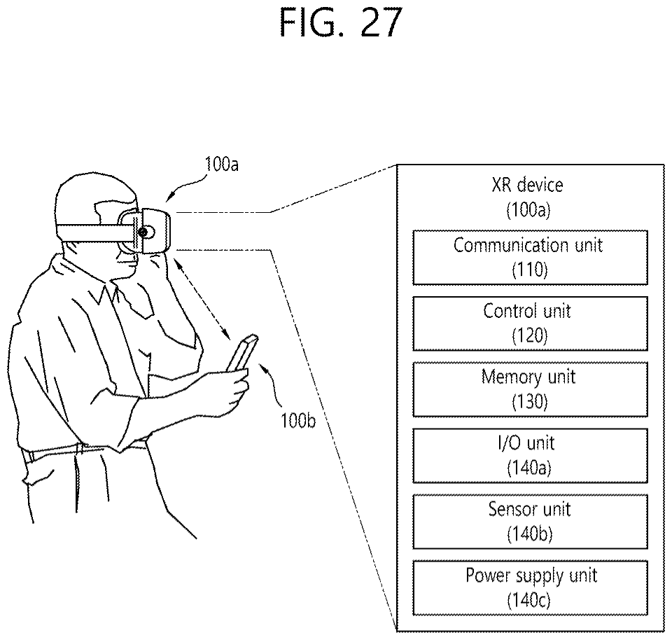

FIG. 27 illustrates a XR device applied to the disclosure. The XR device may be implemented as an HMD, a head-up display (HUD) provided in a vehicle, a television, a smartphone, a computer, a wearable device, a home appliance, a digital signage, a vehicle, a robot, and the like.

Referring to FIG. 27, the XR device 100a may include a communication unit 110, a control unit 120, a memory unit 130, an input/output unit 140a, a sensor unit 140b and a power supply unit 140c. Herein, blocks 110 to 130/140a to 140c correspond to blocks 110 to 130/140 in FIG. 23.

The communication unit 110 may transmit/receive signals (e.g., media data, control signals, etc.) to/from external devices such as other wireless devices, portable devices, or media servers. Media data may include images, images, sounds, and the like. The control unit 120 may control the components of the XR device 100a to perform various operations. For example, the control unit 120 may be configured to control and/or perform procedures such as video/image acquisition, (video/image) encoding, and metadata generation and processing. The memory unit 130 may store data/parameters/programs/codes/commands necessary for driving the XR device 100a/creating an XR object. The input/output unit 140a may obtain control information, data, and the like from the outside, and may output the generated XR object. The input/output unit 140a may include a camera, a microphone, a user input unit, a display unit, a speaker, and/or a haptic module. The sensor unit 140b may obtain an XR device state, surrounding environment information, user information, and the like. The sensor unit 140b may include a proximity sensor, an illumination sensor, an acceleration sensor, a magnetic sensor, a gyro sensor, an inertial sensor, a RGB sensor, an IR sensor, a fingerprint recognition sensor, an ultrasonic sensor, an optical sensor, a microphone, and/or a radar. The power supply unit 140c supplies power to the XR device 100a, and may include a wired/wireless charging circuit, a battery, and the like.

For example, the memory unit 130 of the XR device 100a may include information (e.g., data, etc.) necessary for generating an XR object (e.g., AR/VR/MR object). The input/output unit 140a may obtain a command to operate the XR device 100a from the user, and the control unit 120 may drive the XR device 100a according to the user's driving command. For example, when the user wants to watch a movie or news through the XR device 100a, the control unit 120 transmits the content request information through the communication unit 130 to another device (e.g., the mobile device 100b) or can be sent to the media server. The communication unit 130 may download/stream contents such as movies and news from another device (e.g., the portable device 100b) or a media server to the memory unit 130. The control unit 120 controls and/or performs procedures such as video/image acquisition, (video/image) encoding, and metadata generation/processing for the content, and is acquired through the input/output unit 140a/the sensor unit 140b An XR object can be generated/output based on information about one surrounding space or a real object.

Also, the XR device 100a is wirelessly connected to the portable device 100b through the communication unit 110, and the operation of the XR device 100a may be controlled by the portable device 100b. For example, the portable device 100b may operate as a controller for the XR device 100a. To this end, the XR device 100a may obtain 3D location information of the portable device 100b, and then generate and output an XR object corresponding to the portable device 100b.

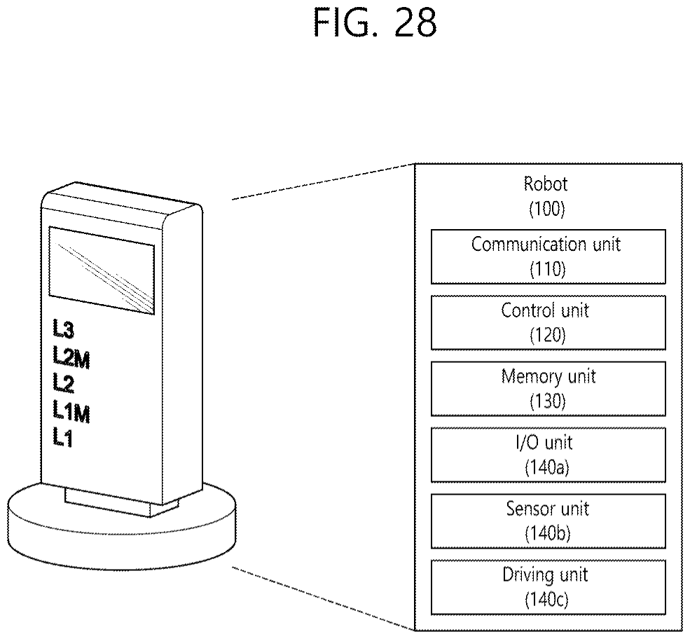

FIG. 28 illustrates a robot applied to the disclosure. The robot may be classified into industrial, medical, home, military, and the like depending on the purpose or field of use.

Referring to FIG. 28, the robot 100 may include a communication unit 110, a control unit 120, a memory unit 130, an input/output unit 140a, a sensor unit 140b, and a driving unit 140c. Herein, blocks 110 to 130/140a to 140c correspond to blocks 110 to 130/140 in FIG. 23.

The communication unit 110 may transmit/receive signals (e.g., driving information, control signal, etc.) to/from external device such as other wireless device, other robot, or a control server. The control unit 120 may perform various operations by controlling the components of the robot 100. The memory unit 130 may store data/parameters/programs/codes/commands supporting various functions of the robot 100. The input/output unit 140a may obtain information from the outside of the robot 100 and may output information to the outside of the robot 100. The input/output unit 140a may include a camera, a microphone, an user input unit, a display unit, a speaker, and/or a haptic module, etc. The sensor unit 140b may obtain internal information, surrounding environment information, user information and the like of the robot 100. The sensor unit may include a proximity sensor, an illumination sensor, an acceleration sensor, a magnetic sensor, a gyro sensor, an inertial sensor, an IR sensor, a fingerprint recognition sensor, an ultrasonic sensor, an optical sensor, a microphone, a radar, and the like. The driving unit 140c may perform various physical operations such as moving a robot joint. In addition, the driving unit 140c may make the robot 100 travel on the ground or fly in the air. The driving unit 140c may include an actuator, a motor, a wheel, a brake, a propeller, and the like.

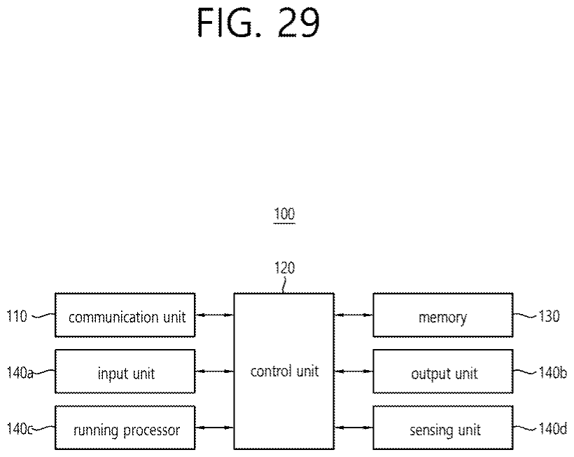

FIG. 29 illustrates an AI device applied to the disclosure. The AI device may be implemented as a stationary device or a mobile device, such as a TV, a projector, a smartphone, a PC, a laptop, a digital broadcasting terminal, a tablet PC, a wearable device, a set-top box, a radio, a washing machine, a refrigerator, digital signage, a robot, and a vehicle.

Referring to FIG. 29, the AI device 100 may include a communication unit 110, a control unit 120, a memory unit 130, an input unit 140a, an output unit 140b, a learning processor unit 140c, and a sensor unit 140d. Blocks 110 to 130/140a to 140d correspond to the blocks 110 to 130/140 of FIG. 23, respectively.

The communication unit 110 may transmit and receive wired or wireless signals (e.g., sensor information, a user input, a learning mode, a control signal, or the like) to and from external devices, a different AI device (e.g., 100x, 200, or 400 in FIG. 20) or an AI server (e.g., 400 in FIG. 20) using wired or wireless communication technologies. To this end, the communication unit 110 may transmit information in the memory unit 130 to an external device or may transmit a signal received from the external device to the memory unit 130.

The control unit 120 may determine at least one executable operation of the AI device 100 on the basis of information determined or generated using a data analysis algorithm or a machine-learning algorithm. The control unit 120 may control components of the AI device 100 to perform the determined operation. For example, the control unit 120 may request, retrieve, receive, or utilize data of the learning processor unit 140c or the memory unit 130 and may control components of the AI device 100 to perform a predicted operation or an operation determined to be preferable among the at least one executable operation. The control unit 120 may collect history information including details about an operation of the AI device 100 or a user's feedback on the operation and may store the history information in the memory unit 130 or the learning processor unit 140c or may transmit the history information to an external device, such as the AI server (400 in FIG. 20). The collected history information may be used to update a learning model.

The memory unit 130 may store data for supporting various functions of the AI device 100. For example, the memory unit 130 may store data obtained from the input unit 140a, data obtained from the communication unit 110, output data from the learning processor unit 140c, and data obtained from the sensing unit 140. Further, the memory unit 130 may store control information and/or a software code necessary for the operation/execution of the control unit 120.

The input unit 140a may obtain various types of data from the outside of the AI device 100. For example, the input unit 140a may obtain learning data for model learning and input data to which a learning model is applied. The input unit 140a may include a camera, a microphone, and/or a user input unit. The output unit 140b may generate visual, auditory, or tactile output. The output unit 140b may include a display unit, a speaker, and/or a haptic module. The sensing unit 140 may obtain at least one of internal information about the AI device 100, environmental information about the AI device 100, and user information using various sensors. The sensing unit 140 may include a proximity sensor, an illuminance sensor, an acceleration sensor, a magnetic sensor, a gyro sensor, an inertial sensor, an RGB sensor, an IR sensor, a fingerprint sensor, an ultrasonic sensor, an optical sensor, a microphone, and/or a radar.

The learning processor unit 140c may train a model including artificial neural networks using learning data. The learning processor unit 140c may perform AI processing together with a learning processor unit of an AI server (400 in FIG. 20). The learning processor unit 140c may process information received from an external device through the communication unit 110 and/or information stored in the memory unit 130. In addition, an output value from the learning processor unit 140c may be transmitted to an external device through the communication unit 110 and/or may be stored in the memory unit 130.

The claims set forth herein can be combined in a variety of ways. For example, the technical features of the method claims of this specification may be combined to be implemented as a device, and the technical features of the device claims of this specification may be combined to be implemented as a method. In addition, the technical features of the method claims of the present specification and the technical features of the device claims may be combined to be implemented as a device, and the technical features of the method claims of the present specification and the technical features of the device claims may be combined to be implemented as a method.

What is claimed is:

1. A method of power control in a wireless communication system, the method performed by an integrated access and backhaul (IAB) node and comprising:
receiving power information, wherein the power information informs a power control method set for the IAB node;
based on a sum of MT power for MT transmission and DU power for DU transmission greater than a maximum transmission power allocated to the IAB node, performing power control for at least one of the MT power and the DU power based on the power information; and
performing the MT transmission and the DU transmission based on the power control,
wherein the MT transmission is a transmission to a parent node of the IAB node, and the DU transmission is a transmission to a child node of the IAB node, and
wherein MT resource on which the MT transmission is performed and DU resource on which the DU transmission is performed overlap in a time domain.

2. The method of claim 1, wherein the power control method sets the MT power to a maximum.

3. The method of claim 1, wherein the power control method sets the DU power to a maximum.

4. The method of claim 1, wherein the power control method controls power based on a first time interval in which maximum DU power is set and a second time interval in which maximum MT power is set.

5. The method of claim 1, wherein the power control method sets maximum DU power or maximum MT power based on a signal transmitted by the DU transmission and the MT transmission.

6. The method of claim 5, wherein maximum DU power is set for the DU transmission based on a resource in which the DU transmission is performed is set as a hard resource,
wherein the hard resource is a resource always available for a DU of the IAB node.

7. The method of claim 6, wherein, based on the DU transmission for a specific signal being configured on a resource on which the DU transmission is performed, the resource is always available for the DU of the IAB node.

8. The method of claim 7, wherein the specific signal includes a synchronization signal/physical broadcast channel block (SS/PBCH block) and an aperiodic channel state information-reference signal (CSI-RS).

9. The method of claim 1, wherein the power control method allocates power in order in which the IAB node receives a grant during the MT transmission and the DU transmission.

10. The method of claim 1, wherein the power control method allocates power in order of a relatively larger amount of information included in a buffer during the MT transmission and the DU transmission.

11. The method of claim 1, wherein the power control method determines a priority of power allocation among the MT transmission and the DU transmission based on resource availability information and availability indication (AI) information,
wherein the resource availability information indicates whether a specific resource is a hard resource, a soft resource, or a not-available resource,
wherein the AI information indicates availability of the soft resource.

12. The method of claim 11, wherein maximum DU power is set for the DU transmission on a resource set as the hard resource based on an availability of the resource and a resource indicated to be available by the AI information.

13. The method of claim 1, wherein the IAB node performs puncturing or rate-matching on transmission to which maximum power is not allocated based on the power control.

14. The method of claim 13, wherein the puncturing and the rate-matching are performed for a resource in which the MT transmission and the DU transmission overlap in a time domain.

15. An integrated access and backhaul (IAB) node comprising:
one or more memories to store instructions;
one or more transceivers; and
one or more processors coupling the one or more memories and the one or more transceivers, wherein the one or more processors execute the instructions for:
receiving power information, wherein the power information informs a power control method set for the IAB node;
based on a sum of MT power for MT transmission and DU power for DU transmission greater than a maximum transmission power allocated to the IAB node, performing power control for at least one of the MT power and the DU power based on the power information; and
performing the MT transmission and the DU transmission based on the power control,
wherein the MT transmission is a transmission to a parent node of the IAB node, and the DU transmission is a transmission to a child node of the IAB node, and
wherein MT resource on which the MT transmission is performed and DU resource on which the DU transmission is performed overlap in a time domain.

16. An apparatus configured to control an integrated access and backhaul (IAB) node, wherein the apparatus comprises:
one or more processors; and
one or more memories executablely coupled by the one or more processors and storing instructions, wherein the one or more processors execute the instructions for:
receiving power information, wherein the power information informs a power control method set for the IAB node;
based on a sum of MT power for MT transmission and DU power for DU transmission greater than a maximum transmission power allocated to the IAB node, performing power control for at least one of the MT power and the DU power based on the power information; and
performing the MT transmission and the DU transmission based on the power control,
wherein the MT transmission is a transmission to a parent node of the IAB node, and the DU transmission is a transmission to a child node of the IAB node, and
wherein MT resource on which the MT transmission is performed and DU resource on which the DU transmission is performed overlap in a time domain.

17. At least one computer readable medium containing instructions that are based on being executed by at least one processor, the instructions for:
receiving power information, wherein the power information informs a power control method set for the IAB node;
based on a sum of MT power for MT transmission and DU power for DU transmission greater than a maximum transmission power allocated to the IAB node, performing power control for at least one of the MT power and the DU power based on the power information; and
performing the MT transmission and the DU transmission based on the power control,
wherein the MT transmission is a transmission to a parent node of the IAB node, and the DU transmission is a transmission to a child node of the IAB node, and
wherein MT resource on which the MT transmission is performed and DU resource on which the DU transmission is performed overlap in a time domain.

18. A method for a signal in a wireless communication system, the method performed by a first integrated access and backhaul (IAB) node and comprising:
transmitting power information to a second IAB node, wherein the power information informs a power control method applied to the second IAB node; and
receiving a signal from the second IAB node,
wherein, based on a sum of MT power for MT transmission of the second IAB node and DU power for DU transmission of the second IAB node greater than maximum transmission power allocated to the second IAB node, transmission power for the signal is determined by the second IAB node,
wherein the second IAB node is a child node of the first IAB node,
wherein the MT transmission is a transmission of the second IAB node to the first IAB node, the DU transmission is a transmission to a child node of the second IAB node, and
wherein a MT resource on which the MT transmission is performed and a DU resource on which the DU transmission is performed overlap in a time domain.

19. A first integrated access and backhaul (IAB) node comprising:
one or more memories to store instructions;
one or more transceivers; and
one or more processors coupling the one or more memories and the one or more transceivers, wherein the one or more processors execute the instructions for:
receiving a signal from the second IAB node,
wherein, based on a sum of MT power for MT transmission of the second IAB node and DU power for DU transmission of the second IAB node greater than maximum transmission power allocated to the second IAB node, transmission power for the signal is determined by the second IAB node,
wherein the second IAB node is a child node of the first IAB node,
wherein the MT transmission is a transmission of the second LAB node to the first IAB node, the DU transmission is a transmission to a child node of the second IAB node, and
wherein a MT resource on which the MT transmission is performed and a DU resource on which the DU transmission is performed overlap in a time domain.
